(19) United States
(12) Patent Application Publication
(10) Pub. No.: US 2026/0249220 A1
(43) Pub. Date: Aug. 27, 2026

(54) IMPROVEMENTS IN OR RELATING TO GAS APPARATUS

(71) Applicant: Peak Scientific Instruments Limited, Renfrew (GB)

(72) Inventor: Marcos Orellana Barcelo, Renfrew (GB)

(73) Assignee: Peak Scientific Instruments Limited, Renfrew, SC (GB)

(21) Appl. No.: 18/996,055

(22) PCT Filed: Jul. 17, 2023
(86) PCT No.: PCT/GB2023/051868

§ 371 Date: Jan. 17, 2025

(30) Foreign Application Priority Data
Jul. 20, 2022 (GB) 2210594.4

(51) Int. Cl. B01D 46/00; B01D 46/46; G05D 9/12

(52) U.S. Cl. CPC B01D 46/0031; B01D 46/46; G05D 9/12

(57) ABSTRACT

A gas generation apparatus comprising a gas inlet configured to allow gas to enter the apparatus, a filter unit configured to filter the gas from the gas inlet, a fluid level control system operable to control the level of fluid removed from the gas by the filter unit, a gas separator configured to separate the gas from the filter unit, and a separated gas outlet configured to receive the separated compressed gas from the gas separator. The fluid level control system comprises a fluid level control apparatus comprising a body portion having a fluid inlet and a fluid outlet, a first sensor module configured to sense fluid at a first position within the body portion, a second sensor module configured to sense fluid at a second position within the body portion, a control module configured to receive output signals from the first and second sensor modules and send a fluid outlet valve control signal, and a fluid outlet valve.

The present invention relates to a gas generation apparatus, gas processing apparatus, a fluid level control apparatus, a fluid level control system, and methods of operating the same. The present invention also relates to a valve apparatus, a method of operating the same, a gas processing apparatus incorporating the valve apparatus, a gas generation apparatus incorporating the valve apparatus and methods of operating the same.

Gas processing and generation apparatuses including air intake units, compressor units, air filter units, water drain systems and gas storage tanks are known. While such apparatuses are capable of processing and generating filtered atmospheric air, they are susceptible to problems with gas purity and malfunction.

The present inventors have appreciated the shortcomings in the above-described apparatus and systems.

According to a first aspect of the present invention there is provided a fluid level control apparatus comprising:
a body portion having a fluid inlet and a fluid outlet;
a first sensor module, the first sensor module being configured to sense fluid at a first position within the body portion;
a second sensor module, the second sensor module being configured to sense fluid at a second position within the body portion; and
a control module, the control module being configured to receive output signals from the first and second sensor modules, and send a fluid outlet valve control signal.

The fluid level control apparatus may be a sensor. The fluid level control apparatus may be a sensor apparatus. The fluid level control apparatus may be for a gas generation apparatus. The fluid level control apparatus may be for a fluid drain system of a gas generation apparatus. The fluid level control apparatus may be for a fluid drain system of a compressor.

The fluid level control apparatus may be automatically operable. The control module may be configured to monitor the operation of the first and second sensor modules and control the operation of the fluid outlet valve. The control module may be configured to operate in dependence of the output signals received from the first and second sensor modules.

The fluid level control apparatus may be operable to control the fluid level in a gas generation apparatus. The fluid level control apparatus may be operable to control the fluid level in the fluid drainage system of a gas generation apparatus. The fluid level control apparatus may be operable to control the fluid level in the fluid drainage system of a moisture removal system of a gas generation apparatus. The fluid level control apparatus may be operable to control the fluid level in the fluid drainage system of a moisture removal system of a compressed air system.

The fluid level control apparatus may be operable to control the water level in a gas generation apparatus. The fluid level control apparatus may be operable to control the water level in the fluid drainage system of a gas generation apparatus. The fluid level control apparatus may be operable to control the water level in the fluid drainage system of a moisture removal system of a gas generation apparatus. The fluid level control apparatus may be operable to control the water level in the fluid drainage system of a moisture removal system of a compressed air system.

The source of fluid, water, or moisture may be from a compressor, compressed air system, or the like.

The fluid may be water. The water may be water removed from a moisture removal system of a gas generation apparatus. The water may be formed by the condensation of water vapour removed from a moisture removal system of a gas generation apparatus. The fluid may include one or more types of particulates. The fluid may include particulates found in the environment local to the air intake of the gas generation apparatus or compressor.

The body portion may be a fluid receptacle. The body portion may be configured to hold a volume of fluid therein. The body portion may be substantially cuboid in shape.

The fluid inlet may be located on an upper portion, or top portion, of the body portion. The fluid outlet may be located on a lower portion, or bottom portion, of the body portion. The fluid inlet and fluid outlet may include fittings. The fittings may be ⅜″, ¼″ BSPP (British Standard Pipe Parallel) fittings. However, it should be appreciated that other fittings may be used.

The body portion may have a volume or approximately 8 ml. The body portion may have a volume of between 4 ml and 12 ml. The body portion may have a volume of up to 11.

The body portion may include a longitudinal axis. The longitudinal axis may extend between the top and bottom of the body portion. The body portion may include a lateral axis. The lateral axis may extend between a left side and a right side of the body portion.

Each sensor module may be configured to output one or more signals. The output signal may be indicative of sensed, or detected, fluid. The output signal may be indicative of no sensed, or detected, fluid. Each sensor may be configured to output a signal that varies depending on whether fluid is sensed, or detected, by the sensor or not. The output signal of each sensor may vary depending on whether fluid is sensed, or detected, or not. The output signal of each sensor may vary as a function of fluid level in the body portion.

Each sensor module may output a signal that indicates that no fluid is sensed, or detected, or a signal that fluid is sensed, or detected. Each sensor module may be configured to output one or more fluid level signals. Each fluid level signal may be indicative of a sensed, or detected, fluid.

Each sensor module may directly sense, or detect, fluid. Each sensor module may indirectly sense, or detect, fluid. Each sensor module may sense, or detect, the presence of fluid in the body portion.

Each sensor may be operable to indicate the presence of fluid. Each sensor may be operable to output a signal that represents a change in one or more parameters measured, sensed, or detected, by the sensor.

The control module may be configured to receive one or more fluid level signals from each sensor.

The first sensor module may be located towards a lower portion of the body portion. The second sensor module may be located towards an upper portion of the body portion. The first sensor module may be located at a lower portion of the body portion. The second sensor module may be located at an upper portion of the body portion.

Each sensor module may be an optical sensor. Each sensor module may be configured to transmit and detect light. Each sensor module may be configured to output an electrical signal that is a function of detected light. Each sensor module may be configured to output an electrical signal that is representative of the amount of light detected.

Each sensor module may include a light emitter and a light detector. Each sensor module may include a light emitter and a corresponding light detector.

Each sensor module may include a light emitter, a light detector and a transparent prism.

The light emitter and light detector of each sensor module may emit and detect light between 780 nm and 1 mm.

The light emitter may be a light emitting diode (LED). The light detector may be a photodiode.

The control module may be configured to monitor the output of the light emitter and the light detector. The output electrical signal from each photodiode may be sent to the control module.

The light emitter and light detector may be located within the sensor module. In this arrangement light emitted from the light emitter is refracted via the prism to, and detected by, the light detector.

The control module may be located on the body portion of the fluid level control apparatus. The control module may be attached, or attachable, to the body portion of the fluid level control apparatus.

The control module may include a micro controller (MC). The MC may include a power supply module, an input/output (I/O) module, a processor module, and a programming module. The control module may include one or more programmable memory devices. The control module may include one or more memory storage devices. The control module may include one or more computing devices. The control module may be operable to run one or more computer programs.

The control module may be operable from a 24v/0.1 A DC power source. However, it should be appreciated that other operational power settings may be used.

The control module may be configured to receive fluid level signals from the first and second sensor modules.

The control module may be configured to selectively receive output signals from each sensor module. The control module may be configured to continuously receive output signals from each sensor module.

The control module may be configured to output one or more alarm signals. The one or more alarm signals may be indicative of an unexpected, or undesirable, operating condition of the apparatus. The one or more alarm signals may be audible, visual, electronic, or the like.

The control module may be configured to output one or more alarm signals if either of the sensor modules outputs an unexpected signal.

The control module may be configured to output one or more alarm signals if the second module outputs an unexpected signal. In this arrangement, an unexpected signal output from the second sensor module may be a signal that fluid remains in the body portion when it should not be present.

The control module may output the one or more alarm signals to one or more external independent control systems. The control module may output the one or more alarm signals to a control system of the gas generation apparatus.

Two or more control modules may be linked. The control modules may be linked such that the operation of each of the fluid level control apparatuses may be controlled. In this arrangement, if one control module receives a signal which is indicative of an unexpected, or undesirable, operating condition, the operation of gas generation apparatus may be halted.

The control module may include an apparatus status indication device. The apparatus status indication device may be configured to indicate a status, or an operating condition of the apparatus. The apparatus status indication device may be configured to output one or more visual signals and/or audible signals.

The control module may be configured to send the fluid outlet valve control signal in dependence on one or more signals received from each sensor module. The control module may be configured to send the fluid outlet valve control signal selectively in dependence on one or more signals received from each sensor module.

The control module may be configured to send the outlet valve control signal to a fluid outlet valve. The control module may be configured to control the opening and closing of the fluid outlet valve. The control module may be configured to actuate the fluid outlet valve. The fluid outlet valve may be configured to control the flow of fluid out of the apparatus. The fluid outlet valve may be configured to control the flow of fluid out of the body portion of the apparatus.

The fluid outlet valve may be a separate component to the fluid level control apparatus. The fluid outlet valve may be part of the fluid level control apparatus.

The fluid outlet valve may be an electronically-controlled valve. The fluid outlet valve may be a solenoid valve.

The control module may be operable to actuate the valve. The control module may be operable control the flow rate of fluid through the valve. The control module may be operable to control the flow rate of fluid from the body portion.

The control module may be operable to open and close the valve. The control module may be operable to modulate the opening and closing of the valve. The control module may be operable to open and close the valve utilising a variable pulse. The variable pulse may be determined by the time taken for the second sensor to detect fluid and no fluid. The pulse period may then be fixed during a cycle. The pulse period may vary dependent on the amount of fluid present/condensed.

The control module may be operable to pulse the opening and closing of the valve. The control module may be operable to pulse the opening and closing of the valve at one or more predetermined intervals. The control module may be operable to pulse the opening and closing of the valve at intervals dependent on one or more system conditions. The control module may be operable to pulse the opening and closing of the valve at intervals dependent on one or more system conditions of a gas generation apparatus, compressor, or the like.

The control module may be operable to vary the periods, or frequencies, at which the valve opens and closes.

The control module may use pulse width modulation (PWM) to operate the opening and closing of the valve.

The fluid outlet valve may be a drain, or drainage, valve.

The control module may be configured to control the operation of the fluid outlet valve.

The fluid level control apparatus may further comprise a fluid outlet valve. The fluid outlet valve may be configured to control the flow of fluid out of the apparatus.

The fluid level control apparatus may further comprise a housing. The body portion, first and second sensor modules and control module may be located in the housing.

The fluid level control apparatus may further comprise a fluid outlet valve. The body portion, first and second sensor modules, control module and fluid outlet valve may be located in the housing.

According to a second aspect of the present invention there is provided a fluid level control system comprising:
a fluid level control apparatus comprising:
   a body portion having a fluid inlet and a fluid outlet;
   a first sensor module, the first sensor module being configured to sense fluid at a first position within the body portion;
   a second sensor module, the second sensor module being configured to sense fluid at a second position within the body portion; and
   a control module, the control module being configured to receive output signals from the first and second sensor modules, and send a fluid outlet valve control signal; and
a fluid outlet valve.

The control module may be configured to send the fluid outlet valve control signal in dependence on one or more signals received from each sensor module. The control module may be configured to send the fluid outlet valve control signal selectively in dependence on one or more signals received from each sensor module.

The control module may be configured to send the outlet valve control signal to the fluid outlet valve. The fluid outlet valve may be configured to control the flow of fluid out of the fluid level control apparatus. The fluid outlet valve may be configured to control the flow of fluid out of the body portion of the fluid level control apparatus.

The fluid outlet valve may be separate to the fluid level control apparatus. The fluid outlet valve may be part of the fluid level control apparatus.

The fluid outlet valve may be an electronically-controlled valve. The fluid outlet valve may be a solenoid valve.

The control module may be operable to actuate the valve. The control module may be operable control the flow rate of fluid through the valve. The control module may be operable to control the flow rate of fluid from the body portion.

The control module may be operable to open and close the valve. The control module may be operable to modulate the opening and closing of the valve. The control module may be operable to open and close the valve utilising a variable pulse. The variable pulse may be determined by the time taken for the second sensor to detect fluid and no fluid. The pulse period may then be fixed during a cycle. The pulse period may vary dependent on the amount of fluid present/condensed.

The control module may be operable to pulse the opening and closing of the valve. The control module may be operable to pulse the opening and closing of the valve at one or more predetermined intervals. The control module may be operable to pulse the opening and closing of the valve at intervals dependent on one or more system conditions. The control module may be operable to pulse the opening and closing of the valve at intervals dependent on one or more system conditions of a gas generation apparatus, compressor, or the like.

The control module may be operable to vary the periods, or frequencies, at which the valve opens and closes.

The control module may use pulse width modulation (PWM) to operate the opening and closing of the valve.

The fluid outlet valve may be a drain valve.

The control module may be configured to control the operation of the fluid outlet valve.

The fluid level control system may include two or more fluid level control apparatuses.

Each fluid level control apparatus may have a corresponding fluid outlet valve.

The fluid level control system may include two or more fluid outlet valves.

Each fluid outlet valve may be associated with a corresponding fluid level control apparatus.

Each fluid level control apparatus may include a control module.

The fluid level control apparatus and the fluid outlet valve may be located in a housing of the fluid level control system. Each fluid level control apparatus and fluid outlet valve may be located in a housing of the fluid level control system.

Embodiments of the second aspect of the present invention may include one or more features of the first aspect of the present invention or its embodiments. Similarly, embodiments of the first aspect of the present invention may include one or more features of the second aspect of the present invention or its embodiments.

According to a third aspect of the present invention there is provided a fluid level control system comprising:

two or more fluid level control apparatus, each fluid level control apparatus comprising:
a body portion having a fluid inlet and a fluid outlet;
   a first sensor module, the first sensor module being configured to sense fluid at a first position within the body portion;
a second sensor module, the second sensor module being configured to sense fluid at a second position within the body portion;
a control module, the control module being configured to receive output signals from each of the first and second sensor modules, and send a fluid outlet valve control signal.

The control module may be configured to send the fluid outlet valve control signal in dependence on one or more signals received from each sensor module. The control module may be configured to send the fluid outlet valve control signal selectively in dependence on one or more signals received from each sensor module.

The control module may be configured to send the outlet valve control signal to a fluid outlet valve. The fluid outlet valve may be configured to control the flow of fluid out of each fluid level control apparatus. The fluid outlet valve may be configured to control the flow of fluid out of the body portion of each apparatus.

The fluid outlet valve may be separate to the fluid level control system. The fluid outlet valve may be part of the fluid level control system.

Each fluid level control apparatus may include a fluid outlet valve.

The fluid outlet valve may be an electronically-controlled valve. The fluid outlet valve may be a solenoid valve.

The control module may be operable to actuate the valve. The control module may be operable control the flow rate of fluid through the valve. The control module may be operable to control the flow rate of fluid from the body portion.

The control module may be operable to open and close the valve. The control module may be operable to modulate the opening and closing of the valve. The control module may be operable to open and close the valve utilising a variable pulse. The variable pulse may be determined by the time taken for the second sensor to detect fluid and no fluid. The pulse period may then be fixed during a cycle. The pulse period may vary dependent on the amount of fluid present/condensed.

The control module may be operable to pulse the opening and closing of the valve. The control module may be operable to pulse the opening and closing of the valve at one or more predetermined intervals. The control module may be operable to pulse the opening and closing of the valve at intervals dependent on one or more system conditions. The control module may be operable to pulse the opening and closing of the valve at intervals dependent on one or more system conditions of a gas generation apparatus, compressor, or the like.

The control module may be operable to vary the periods, or frequencies, at which the valve opens and closes.

The control module may use pulse width modulation (PWM) to operate the opening and closing of the valve.

The fluid outlet valve may be a drain valve.

The control module may be configured to control the operation of the fluid outlet valve.

The fluid level control system may further comprise a fluid outlet valve. The fluid outlet valve may be configured to control the flow of fluid out of the system.

Each fluid level control apparatus may have a corresponding fluid outlet valve.

The fluid level control system may include two or more fluid outlet valves. Each fluid outlet valve may be associated with a corresponding fluid level control apparatus.

Each fluid level control apparatus may include a control module.

Each fluid level control apparatus and fluid outlet valve may be located in a housing of the fluid level control system. Each fluid level control apparatus and fluid outlet valve may be located in a housing of the fluid level control system.

Embodiments of the third aspect of the present invention may include one or more features of the first, or second aspects of the present invention or its embodiments. Similarly, embodiments of the first, or second aspects of the present invention may include one or more features of the third aspect of the present invention or its embodiments.

According to a fourth aspect of the present invention there is provided a gas generation apparatus comprising:
a gas intake unit;
a compressor unit, the compressor unit being operable to draw gas through the gas intake unit and into the compressor unit;
a filter unit, the filter unit being configured to filter the compressed gas from the compressor unit;
a fluid level control system, the fluid level control system being operable to control the level of fluid removed from the compressed gas by the filter unit, the fluid level control system comprising:
   a fluid level control apparatus comprising:
      a body portion having a fluid inlet and a fluid outlet;
      a first sensor module, the first sensor module being configured to sense fluid at a first position within the body portion;
      a second sensor module, the second sensor module being configured to sense fluid at a second position within the body portion; and
      a control module, the control module being configured to receive output signals from the first and second sensor modules, and send a fluid outlet valve control signal; and
   a fluid outlet valve;
a gas separator, the gas separator being configured to separate the compressed gas from the filter unit; and
a gas storage tank, the gas storage tank being configured to receive and store the separated compressed gas from the gas separator.

The gas intake unit may be an air intake unit.

The compressor unit may be operable to draw atmospheric air through the gas intake unit.

The gas may be atmospheric air.

The gas generation apparatus may further include one or more cooling units. The one or more cooling units may be located between the compressor unit and the filter unit. The cooling units may be fin tube coolers, cooling coils, or the like. The purpose of the cooling units is to cool the compressed gas from the compressor unit.

The filter unit may be a fluid filter unit. The filter unit may be a vapour filter unit. The filter unit may be a fluid and vapour filter unit. The filter unit may be a fluid, vapour and particulate filter unit. The filter unit may be configured to remove fluid, vapour or particulates from the compressed gas from the compressor unit. The filter unit may be configured to remove moisture, coarse particulates and fine particulates from the compressed gas from the compressor unit.

The filter unit may include two or more filter components. Each filter component may include a predetermined filter characteristic. The filter unit may include three filter components. Each filter component may include a predetermined filter characteristic. The filter unit may include a plurality of filter components. Each filter component may include a predetermined filter characteristic.

The filter unit may include a first filter component. The first filter component may be configured to filter fluid from the compressed gas. The first filter component may be configured to filter fluid, vapour and particulates from the compressed gas. The first filter component may be configured to filter fluid in the form of liquid and/or vapour from the compressed gas.

The filter unit may include a second filter component. The second filter component may be configured to filter coarse particulates from the compressed gas. The coarse particulates may be mist or vapour.

The filter unit may include a third filter component. The third filter component may be configured to filter fine particulates from the compressed gas. Fine particulates may be any material or substance larger than 0.1 Micron.

The fluid level control system may comprise two or more fluid level control apparatuses. The fluid level control system may comprise three fluid level control apparatuses.

A first fluid level control apparatus may be configured to operate with the first filter component of the filter unit.

A second fluid level control apparatus may be configured to operate with the second filter component of the filter unit.

A third fluid level control apparatus may be configured to operate with the third filter component of the filter unit.

The gas separator may be an air filter unit. The gas separator may be an air separator unit.

The gas separator may be configured to separate the compressed gas into one or more components. The gas separator of the gas generation apparatus may be configured to separate out substantially all but one of the gas components of the compressed gas. The gas separator of the gas generation apparatus may be configured to selectively separate out substantially all but one of the gas components of the compressed gas.

Where the compressed gas is compressed atmospheric air, the gas separator may be configured to separate the compressed atmospheric air from the filter unit into at least one of its constituent gas components. That is, the gas separator of the gas generation apparatus may be configured to separate out substantially all but one of the gas components of the atmospheric air. The gas separator of the gas generation apparatus may therefore be operable to selectively separate out four out of the five main gases present in atmospheric air. The remaining gas present after passing the compressed atmospheric air through the gas separator of the gas generation apparatus may therefore be nitrogen, oxygen, argon or carbon dioxide.

The gas separator of the gas generation apparatus may be a membrane filter. The gas separator of the gas generation apparatus may be a carbon molecular sieve filter. The gas separator of the gas generation apparatus may be a mol sieve filter. The gas separator of the gas generation apparatus may be a dryer membrane filter. The gas separator of the gas generation apparatus may be a hollow fibre membrane filter. The gas separator of the gas generation apparatus may be a molecular sieve. The gas separator of the gas generation apparatus may be a catalytic reactor. The gas separator may be a hydrocarbon molecular sieve. The gas separator may be a membrane. The gas separator may be a pressure swing adsorption (PSA) apparatus. The gas separator may be a vacuum pressure swing adsorption (VPSA) apparatus. The gas separator may be a catalytic reaction apparatus. The gas separator may be a thermal swing adsorption (TSA) apparatus. The gas separator may be an electrolysis apparatus. The gas separator may be a fractional distillation apparatus. The gas separator may be a chemical reaction apparatus.

The gas storage tank may be connectable to a gas output circuit.

The gas generation apparatus may comprise two or more compressor units. Each compressor unit may draw gas through the gas intake unit. Alternatively, the gas generation apparatus may include two or more air intake units, and each compressor may operate with its own gas intake unit. In this arrangement, each compressor unit includes its own filter unit, fluid level control system, gas separator and gas storage tank. Each gas separator may be configured to separate a different constituent gas component from the gas. Each gas separator may be configured to separate the same constituent gas component from the gas.

Where the compressed gas is compressed atmospheric air, each gas separator may be configured to filter a different constituent gas component from the atmospheric air. Each gas separator may be configured to filter the same constituent gas component from the atmospheric air.

The gas generation apparatus may include two or more compressor units, each compressor unit being configured to operate with a filter unit, a fluid level control system, a gas separator and a gas storage tank.

Embodiments of the fourth aspect of the present invention may include one or more features of the first, second or third aspects of the present invention or their embodiments. Similarly, embodiments of the first, second or third aspects of the present invention may include one or more features of the fourth aspect of the present invention or its embodiments.

According to a fifth aspect of the present invention, there is provided a method of controlling fluid level in an apparatus comprising the steps of:
providing a fluid level control apparatus comprising:
   a body portion having a fluid inlet and a fluid outlet;
   a first sensor module, the first sensor module being configured to sense fluid at a first position within the body portion; a second sensor module, the second sensor module being configured to sense fluid at a second position within the body portion;
   a control module, the control module being configured to receive output signals from the first and second sensor modules, and send a fluid outlet valve control signal; and
   a fluid outlet valve;
operating the first sensor module to output a fluid level signal to the control module;
operating the second sensor module to output a fluid level signal to the control module; and
operating the control module to send the fluid outlet valve control signal to the fluid outlet valve in dependence on the fluid level signals received from the first and second sensor modules.

The control module may be operable selectively send the fluid outlet valve control signal to the fluid outlet valve.

Embodiments of the fifth aspect of the present invention may include one or more features of the first, second, third or fourth aspects of the present invention or their embodiments. Similarly, embodiments of the first, second, third or fourth aspects of the present invention may include one or more features of the fifth aspect of the present invention or its embodiments.

According to a sixth aspect of the present invention there is provided a method of generating gas comprising the steps of:
providing a gas generation apparatus comprising:
   a gas intake unit;
   a compressor unit, the compressor unit being operable to draw gas through the gas intake unit and into the compressor unit;
   a filter unit, the filter unit being configured to filter the compressed gas from the compressor unit;
   a fluid level control system, the fluid level control system being operable to control the level of fluid removed from the compressed gas by the filter unit, the fluid level control system comprising:
      a fluid level control apparatus comprising:
         a body portion having a fluid inlet and a fluid outlet;
         a first sensor module, the first sensor module being configured to sense fluid at a first position within the body portion;
         a second sensor module, the second sensor module being configured to sense fluid at a second position within the body portion; and
         a control module, the control module being configured to receive output signals from the first and second sensor modules, and send a fluid outlet valve control signal; and
      a fluid outlet valve;
   a gas separator, the gas separator being configured to separate the compressed gas from the filter unit; and
   a gas storage tank, the gas storage tank being configured to receive and store the separated compressed gas from the gas separator,
operating the compressor unit to draw gas through the gas intake unit into the compressor unit;
filtering the compressed gas from the compressor unit with the filter unit;
operating the fluid level control system to control the level of fluid removed from the compressed gas by the filter unit;
separating the compressed gas from the filter unit with the gas separator; and
storing the separated gas from the gas separator in the gas storage tank.

The gas intake unit may be an air intake unit.

The compressor unit may be operable to draw atmospheric air through the gas intake unit.

The gas may be atmospheric air.

Embodiments of the sixth aspect of the present invention may include one or more features of the first, second, third, fourth or fifth aspects of the present invention or their embodiments. Similarly, embodiments of the first, second, third, fourth or fifth aspects of the present invention may include one or more features of the sixth aspect of the present invention or its embodiments.

According to a seventh aspect of the present invention there is provided a fluid level control system comprising:
a fluid level control apparatus comprising:
   a body portion having a fluid inlet and a fluid outlet;
   a first sensor module, the first sensor module being configured to sense fluid at a first position within the body portion;
   a second sensor module, the second sensor module being configured to sense fluid at a second position within the body portion; and
   a control module, the control module being configured to receive output signals from the first and second sensor modules, and send a fluid outlet valve control signal; and
a housing, the fluid level control apparatus being located in the housing.

The control module may be configured to send the fluid outlet valve control signal in dependence on one or more signals received from each sensor module. The control module may be configured to send the fluid outlet valve control signal selectively in dependence on one or more signals received from each sensor module.

The fluid level control apparatus may further comprise a fluid outlet valve.

The control module may be configured to send the outlet valve control signal to the fluid outlet valve. The fluid outlet valve may be configured to control the flow of fluid out of the fluid level control apparatus. The fluid outlet valve may be configured to control the flow of fluid out of the body portion of the fluid level control apparatus.

The fluid outlet valve may be separate to the fluid level control apparatus. The fluid outlet valve may be part of the fluid level control apparatus.

The fluid outlet valve may be an electronically-controlled valve. The fluid outlet valve may be a solenoid valve.

The control module may be operable to actuate the valve. The control module may be operable control the flow rate of fluid through the valve. The control module may be operable to control the flow rate of fluid from the body portion.

The control module may be operable to open and close the valve. The control module may be operable to modulate the opening and closing of the valve. The control module may be operable to open and close the valve utilising a variable pulse. The variable pulse may be determined by the time taken for the second sensor to detect fluid and no fluid. The pulse period may then be fixed during a cycle. The pulse period may vary dependent on the amount of fluid present/condensed.

The control module may be operable to pulse the opening and closing of the valve. The control module may be operable to pulse the opening and closing of the valve at one or more predetermined intervals. The control module may be operable to pulse the opening and closing of the valve at intervals dependent on one or more system conditions. The control module may be operable to pulse the opening and closing of the valve at intervals dependent on one or more system conditions of a gas generation apparatus, compressor, or the like.

The control module may be operable to vary the periods, or frequencies, at which the valve opens and closes.

The control module may use pulse width modulation (PWM) to operate the opening and closing of the valve.

The fluid outlet valve may be a drain valve.

The control module may be configured to control the operation of the fluid outlet valve.

The fluid level control system may include two or more fluid level control apparatuses.

Each fluid level control apparatus may have a corresponding fluid outlet valve.

The fluid level control system may include two or more fluid outlet valves. Each fluid outlet valve may be associated with a corresponding fluid level control apparatus.

Each fluid level control apparatus may include a control module.

The fluid level control apparatus and the fluid outlet valve may be located in the housing of the fluid level control system. Each fluid level control apparatus and fluid outlet valve may be located in the housing of the fluid level control system.

Embodiments of the seventh aspect of the present invention may include one or more features of the first, second, third, fourth, fifth or sixth aspects of the present invention or their embodiments. Similarly, embodiments of the first, second, third, fourth, fifth or sixth aspects of the present invention may include one or more features of the seventh aspect of the present invention or its embodiments.

According to an eighth aspect of the present invention there is provided a gas generation apparatus comprising:
a gas inlet, the gas inlet being configured to allow gas to enter the apparatus;
a filter unit, the filter unit being configured to filter the gas from the gas inlet;
a fluid level control system, the fluid level control system being operable to control the level of fluid removed from the gas by the filter unit, the fluid level control system comprising:
   a fluid level control apparatus comprising:
      a body portion having a fluid inlet and a fluid outlet;
      a first sensor module, the first sensor module being configured to sense fluid at a first position within the body portion;
      a second sensor module, the second sensor module being configured to sense fluid at a second position within the body portion; and
      a control module, the control module being configured to receive output signals from the first and second sensor modules, and send a fluid outlet valve control signal; and
   a fluid outlet valve;
a gas separator, the gas separator being configured to separate the gas from the filter unit; and
a separated gas outlet, the separated gas outlet being configured to receive the separated gas from the gas separator.

The gas intake unit may be an air intake unit. The gas intake unit may be an atmospheric air intake unit. The gas intake unit may be a compressed gas intake unit.

The gas may be atmospheric air. The gas may be compressed gas.

The gas inlet may be configured to draw atmospheric air through the gas inlet and into the apparatus. The gas inlet may include a gas intake unit. The gas intake unit may be operable to draw atmospheric air through the gas inlet and into the gas generation apparatus. The gas intake unit may be operable to draw gas through the gas inlet and into the gas generation apparatus. The gas intake unit may be operable to draw compressed gas through the gas inlet and into the gas generation apparatus.

The gas inlet may be configured to allow cooled atmospheric air to enter the apparatus. The gas inlet may be configured to allow compressed atmospheric air, or compressed gas, to enter the apparatus. The gas inlet may be configured to allow cooled compressed atmospheric air, or cooled compressed gas, to enter the apparatus. The compressed atmospheric air may be cooled compressed atmospheric air. The compressed gas may be cooled compressed gas.

The gas inlet may be configured to be supplied with atmospheric air. The gas inlet may be configured to be supplied with compressed atmospheric air. The gas inlet may be configured to be supplied with cooled, compressed atmospheric air.

The filter unit may be a fluid filter unit. The filter unit may be a vapour filter unit. The filter unit may be a fluid and vapour filter unit. The filter unit may be a fluid, vapour and particulate filter unit. The filter unit may be configured to remove fluid, vapour or particulates from compressed gas from the gas inlet. The filter unit may be configured to remove moisture, coarse particulates and fine particulates from compressed gas from the gas inlet.

The filter unit may include two or more filter components. Each filter component may include a predetermined filter characteristic. The filter unit may include three filter components. Each filter component may include a predetermined filter characteristic. The filter unit may include a plurality of filter components. Each filter component may include a predetermined filter characteristic.

The filter unit may include a first filter component. The first filter component may be configured to filter fluid from compressed gas. The first filter component may be configured to filter fluid, vapour and particulates from compressed gas. The first filter component may be configured to filter fluid in the form of liquid and/or vapour from compressed gas.

The filter unit may include a second filter component. The second filter component may be configured to filter coarse particulates from compressed gas. The coarse particulates may be mist or vapour.

The filter unit may include a third filter component. The third filter component may be configured to filter fine particulates from compressed gas. Fine particulates may be any material or substance larger than 0.1 Micron.

The fluid level control system may comprise two or more fluid level control control apparatuses. The fluid level control system may comprise two fluid level control apparatuses.

A first fluid level control apparatus may be configured to operate with the first filter component of the filter unit.

A second fluid level control apparatus may be configured to operate with the second filter component of the filter unit.

A third fluid level control apparatus may be configured to operate with the third filter component of the filter unit.

The gas separator may be an air filter unit. The gas separator may be an air separator unit.

The gas separator may be configured to separate the gas into one or more components. The gas separator of the gas generation apparatus may be configured to separate out substantially all but one of the gas components of the compressed gas. The gas separator of the gas generation apparatus may be configured to selectively separate out substantially all but one of the gas components of the compressed gas.

Where the compressed gas is compressed atmospheric air, the gas separator may be configured to separate compressed atmospheric air from the filter unit into at least one of its constituent gas components. That is, the gas separator of the gas generation apparatus may be configured to separate out substantially all but one of the gas components of the atmospheric air. The gas separator of the gas generation apparatus may therefore be operable to selectively separate out four out of the five main gases present in atmospheric air. The remaining gas present after passing the compressed atmospheric air through the gas separator of the gas generation apparatus may therefore be nitrogen, oxygen, argon or carbon dioxide.

The gas separator of the gas generation apparatus may be a membrane filter. The gas separator of the gas generation apparatus may be a carbon molecular sieve filter. The gas separator of the gas generation apparatus may be a mol sieve filter. The gas separator of the gas generation apparatus may be a dryer membrane filter. The gas separator of the gas generation apparatus may be a hollow fibre membrane filter. The gas separator of the gas generation apparatus may be a molecular sieve. The gas separator of the gas generation apparatus may be a catalytic reactor. The gas separator may be a hydrocarbon molecular sieve. The gas separator may be a membrane. The gas separator may be a pressure swing adsorption (PSA) apparatus. The gas separator may be a vacuum pressure swing adsorption (VPSA) apparatus. The gas separator may be a catalytic reaction apparatus. The gas separator may be a thermal swing adsorption (TSA) apparatus. The gas separator may be an electrolysis apparatus. The gas separator may be a fractional distillation apparatus. The gas separator may be a chemical reaction apparatus.

The apparatus may further comprise a compressor unit, the compressor unit being operable to draw gas through a gas intake unit, or gas inlet, or inlet filter and into the compressor unit.

The filter unit may be configured to filter the compressed gas from the compressor unit.

The fluid level control system may be operable to control the level of fluid removed from the compressed gas by the filter unit.

The apparatus may further comprise a cooling unit. The cooling unit may be located between the compressor unit and the filter unit. The cooling unit may be a fin tube cooler, a cooling coil, or the like. The purpose of the cooling unit is to cool the compressed gas from the compressor unit.

The filter unit may be configured to remove fluid, vapour or particulates from the compressed gas from the compressor unit. The filter unit may be configured to remove moisture, coarse particulates and fine particulates from the compressed gas from the compressor unit.

The filter unit may include a first filter component. The first filter component may be configured to filter fluid from the compressed gas. The first filter component may be configured to filter fluid, vapour and particulates from the compressed gas. The first filter component may be configured to filter fluid in the form of liquid and/or vapour from the compressed gas.

The filter unit may include a second filter component. The second filter component may be configured to filter coarse particulates from the compressed gas. The coarse particulates may be mist or vapour.

The filter unit may include a third filter component. The third filter component may be configured to filter fine particulates from the compressed gas. Fine particulates may be any material or substance larger than 0.1 Micron.

The apparatus may further comprise a gas storage tank, the gas storage tank being configured to receive and store the separated compressed gas from the gas separator. The gas storage tank may be located between the gas separator and the separated gas outlet.

The second air filter unit of the gas generation apparatus may be configured to separate the compressed gas from the filter unit into at least one of its constituent gas components.

The separated gas outlet may be connectable to a gas output circuit.

The gas generation apparatus may comprise two or more compressor units. Each compressor unit may draw gas through a gas intake unit, or gas inlet, or inlet filter of the compressor unit. Alternatively, the gas generation apparatus may include two or more gas intake units, and each compressor may operate with its own gas intake unit. In this arrangement, each compressor unit includes its own filter unit, fluid level control system, gas separator and separated gas outlet. Each gas separator may be configured to separate a different constituent gas component from the gas. Each gas separator may be configured to separate the same constituent gas component from the gas.

The gas generation apparatus may include two or more compressor units, each compressor unit being configured to operate with a filter unit, a fluid level control system, a gas separator, and a separated gas outlet.

Embodiments of the eighth aspect of the present invention may include one or more features of the first, second, third, fourth, fifth sixth, or seventh aspects of the present invention or their embodiments. Similarly, embodiments of the first, second, third, fourth, fifth, sixth or seventh aspects of the present invention may include one or more features of the eighth aspect of the present invention or its embodiments.

According to a ninth aspect of the present invention there is provided a method of generating gas comprising the steps of:
providing a gas generation apparatus comprising:
   a gas inlet, the gas inlet being configured to allow gas to enter the apparatus;
   a filter unit, the filter unit being configured to filter the gas from the gas inlet;
   a fluid level control system, the fluid level control system being operable to control the level of fluid removed from the gas by the filter unit, the fluid level control system comprising:
      a fluid level control apparatus comprising:
         a body portion having a fluid inlet and a fluid outlet;
         a first sensor module, the first sensor module being configured to sense fluid at a first position within the body portion;
         a second sensor module, the second sensor module being configured to sense fluid at a second position within the body portion; and
         a control module, the control module being configured to receive output signals from the first and second sensor modules, and send a fluid outlet valve control signal; and
      a fluid outlet valve;
   a gas separator, the gas separator being configured to separate the gas from the filter unit; and
   a separated gas outlet, the separated gas outlet being configured to receive the separated compressed gas from the gas separator,
providing gas to the gas inlet;
filtering the gas from the gas inlet with the filter unit;
operating the fluid level control system to control the level of fluid removed from the gas by the filter unit;
separating the gas from the filter unit with the gas separator; and
   providing the separated gas to the separated gas outlet.

The gas intake unit may be an air intake unit.

The gas may be atmospheric air.

Embodiments of the ninth aspect of the present invention may include one or more features of the first, second, third, fourth, fifth sixth, seventh, or eighth aspects of the present invention or their embodiments. Similarly, embodiments of the first, second, third, fourth, fifth, sixth, seventh, or eighth aspects of the present invention may include one or more features of the ninth aspect of the present invention or its embodiments.

According to a tenth aspect of the present invention there is provided a valve apparatus comprising:
a valve; and
a control module, the control module being configured to control the operation of the valve.

The valve apparatus may be for a fluid level control apparatus. The valve may be for a gas generation apparatus. The valve apparatus may be for a fluid drain system of a gas generation apparatus. The valve apparatus may be for a fluid drain system of a compressor.

The valve apparatus may be automatically operable. The control module may be configured to monitor one or more control signals and control the operation of the valve. The control module may be configured to operate in dependence on one or more control signals.

The valve apparatus may be operable to control the fluid level in a gas generation apparatus. The valve apparatus may be operable to control the fluid level in the fluid drainage system of a gas generation apparatus. The valve apparatus may be operable to control the fluid level in the fluid drainage system of a moisture removal system of a gas generation apparatus. The valve apparatus may be operable to control the fluid level in the fluid drainage system of a moisture removal system of a compressed air system.

The valve apparatus may be operable to control the water level in a gas generation apparatus. The valve apparatus may be operable to control the water level in the fluid drainage system of a gas generation apparatus. The valve apparatus may be operable to control the water level in the fluid drainage system of a moisture removal system of a gas generation apparatus. The valve apparatus may be operable to control the water level in the fluid drainage system of a moisture removal system of a compressed air system.

The valve may include a body portion. The control module may be mounted on, or in, the body portion.

The valve apparatus may include a housing. The valve apparatus may be located in the housing.

The control module may send a valve control signal to the valve. The control module may be operable to send a control signal to the valve.

The control module may be located on the body portion of the valve apparatus. The control module may be located on the valve. The control module may be attached, or attachable, to the body portion of the valve apparatus.

The control module may include a micro controller (MC). The MC may include a power supply module, an input/output (I/O) module, a processor module, and a programming module. The control module may include one or more programmable memory devices. The control module may include one or more memory storage devices. The control module may include one or more computing devices. The control module may be operable to run one or more computer programs.

The control module may be operable from a 24v/0.1 A DC power source. However, it should be appreciated that other operational power settings may be used.

The control module may be configured to send the control signal to the valve. The control module may be configured to control the opening and closing of the valve. The control module may be configured to actuate the valve. The valve may be configured to control the flow of fluid through the valve.

The valve may be an electronically-controlled valve. The valve may be a solenoid valve.

The control module may be operable to actuate the valve. The control module may be operable control the flow rate of fluid through the valve.

The control module may be operable to open and close the valve. The control module may be operable to modulate the opening and closing of the valve. The control module may be operable to open and close the valve utilising a variable pulse.

The control module may be operable to pulse the opening and closing of the valve. The control module may be operable to pulse the opening and closing of the valve at one or more predetermined intervals. The control module may be operable to pulse the opening and closing of the valve at intervals dependent on one or more system conditions linked to the valve apparatus. The control module may be operable to pulse the opening and closing of the valve at intervals dependent on one or more system conditions of a system to which the valve apparatus is linked. The control module may be operable to pulse the opening and closing of the valve at intervals dependent on one or more system conditions of a gas generation apparatus, compressor, or the like.

The control module may be operable to vary the periods, or frequencies, at which the valve opens and closes.

The control module may use pulse width modulation (PWM) to operate the opening and closing of the valve.

The valve may be a drain, or drainage, valve.

The control module may be configured to control the operation of the valve.

Embodiments of the tenth aspect of the present invention may include one or more features of the first, second, third, fourth, fifth sixth, seventh, eighth, or ninth aspects of the present invention or their embodiments. Similarly, embodiments of the first, second, third, fourth, fifth, sixth, seventh, eighth, or ninth aspects of the present invention may include one or more features of the tenth aspect of the present invention or its embodiments.

According to an eleventh aspect of the present invention there is provided a method of operating a valve comprising:
providing a valve apparatus comprising:
   a valve; and
   a control module, the control module being configured to control the operation of the valve; and
operating the control module to control the operation of the valve.

The control module may send a valve control signal to the valve. The control module may be operable to send a control signal to the valve.

The control module may be configured to send the control signal to the valve. The control module may be configured to control the opening and closing of the valve. The control module may be configured to actuate the valve. The valve may be configured to control the flow of fluid through the valve.

The valve may be an electronically-controlled valve. The valve may be a

The control module may be operable to actuate the valve. The control module may be operable control the flow rate of fluid through the valve.

The control module may be operable to open and close the valve. The control module may be operable to modulate the opening and closing of the valve. The control module may be operable to open and close the valve utilising a variable pulse. The pulse period may then be fixed during a cycle.

The control module may be operable to pulse the opening and closing of the valve. The control module may be operable to pulse the opening and closing of the valve at one or more predetermined intervals. The control module may be operable to pulse the opening and closing of the valve at intervals dependent on one or more system conditions linked to the valve apparatus. The control module may be operable to pulse the opening and closing of the valve at intervals dependent on one or more system conditions of a system to which the valve apparatus is linked. The control module may be operable to pulse the opening and closing of the valve at intervals dependent on one or more system conditions of a gas generation apparatus, compressor, or the like.

The control module may be operable to vary the periods, or frequencies, at which the valve opens and closes.

The control module may use pulse width modulation (PWM) to operate the opening and closing of the valve.

The valve may be a drain, or drainage, valve.

The control module may be configured to control the operation of the valve.

Embodiments of the eleventh aspect of the present invention may include one or more features of the first, second, third, fourth, fifth sixth, seventh, eighth, ninth, or tenth aspects of the present invention or their embodiments. Similarly, embodiments of the first, second, third, fourth, fifth, sixth, seventh, eighth, ninth, or tenth aspects of the present invention may include one or more features of the eleventh aspect of the present invention or its embodiments.

According to a twelfth aspect of the present invention there is provided a valve apparatus comprising:
a valve;
a control module, the control module being configured to control the operation of the valve; and
a housing, the valve and the control module being located in the housing.

Embodiments of the twelfth aspect of the present invention may include one or more features of the first, second, third, fourth, fifth sixth, seventh, eighth, ninth, tenth, or eleventh aspects of the present invention or their embodiments. Similarly, embodiments of the first, second, third, fourth, fifth, sixth, seventh, eighth, ninth, tenth, or eleventh aspects of the present invention may include one or more features of the twelfth aspect of the present invention or its embodiments.

According to a thirteenth aspect of the present invention there is provided a gas generation apparatus comprising:
a gas inlet, the gas inlet being configured to allow gas to enter the apparatus;
a filter unit, the filter unit being configured to filter the gas from the gas inlet;
a valve apparatus, the valve apparatus being operable to drain fluid removed from the gas by the filter unit, the valve apparatus comprising:
   a valve; and
   a control module, the control module being configured to control the operation of the valve;
a gas separator, the gas separator being configured to separate the gas from the filter unit; and
a separated gas outlet, the separated gas outlet being configured to receive the separated gas from the gas separator.

The gas intake unit may be an air intake unit. The gas may be atmospheric air. The gas may be compressed gas. The gas may be compressed atmospheric air.

Embodiments of the thirteenth aspect of the present invention may include one or more features of the first, second, third, fourth, fifth sixth, seventh, eighth, ninth, tenth, eleventh, or twelfth aspects of the present invention or their embodiments. Similarly, embodiments of the first, second, third, fourth, fifth, sixth, seventh, eighth, ninth, tenth, eleventh, or twelfth aspects of the present invention may include one or more features of the thirteenth aspect of the present invention or its embodiments.

According to a fourteenth aspect of the present invention there is provided a method of generating gas comprising the steps of:
providing a gas generation apparatus comprising:
   a gas inlet, the gas inlet being configured to allow gas to enter the apparatus;
   a filter unit, the filter unit being configured to filter the gas from the gas inlet;
   a valve apparatus, the valve apparatus being operable to drain fluid removed from the gas by the filter unit, the valve apparatus comprising:
      a valve; and
      a control module, the control module being configured to control the operation of the valve;
a gas separator, the gas separator being configured to separate the gas from the filter unit; and
a separated gas outlet, the separated gas outlet being configured to receive the separated gas from the gas separator;
providing gas to the gas inlet;
filtering the gas from the gas inlet with the filter unit;
operating the fluid level control system to control the level of fluid removed from the gas by the filter unit;
separating the gas from the filter unit with the gas separator; and
providing the separated gas to the separated gas outlet.

The gas intake unit may be an air intake unit. The gas may be atmospheric air. The gas may be compressed gas. The gas may be compressed atmospheric air.

Embodiments of the fourteenth aspect of the present invention may include one or more features of the first, second, third, fourth, fifth sixth, seventh, eighth, ninth, tenth, eleventh, twelfth, or thirteenth aspects of the present invention or their embodiments. Similarly, embodiments of the first, second, third, fourth, fifth, sixth, seventh, eighth, ninth, tenth, eleventh, twelfth, or thirteenth aspects of the present invention may include one or more features of the fourteenth aspect of the present invention or its embodiments.

According to a fifteenth aspect of the present invention there is provided a gas processing apparatus comprising:
a gas inlet, the gas inlet being configured to allow gas to enter the apparatus;
a filter unit, the filter unit being configured to filter the gas from the gas inlet;
a fluid level control system, the fluid level control system being operable to control the level of fluid removed from the gas by the filter unit, the fluid level control system comprising:
   a fluid level control apparatus comprising:
      a body portion having a fluid inlet and a fluid outlet;
      a first sensor module, the first sensor module being configured to sense fluid at a first position within the body portion;
      a second sensor module, the second sensor module being configured to sense fluid at a second position within the body portion; and
      a control module, the control module being configured to receive output signals from the first and second sensor modules, and send a fluid outlet valve control signal; and
   a fluid outlet valve;
a gas outlet, the gas outlet being configured to receive the gas from the filter unit.

The gas intake unit may be an air intake unit. The gas intake unit may be an atmospheric air intake unit. The gas intake unit may be a compressed gas intake unit.

The gas may be atmospheric air. The gas may be compressed gas.

The gas inlet may be configured to draw atmospheric air through the gas inlet and into the apparatus. The gas inlet may include a gas intake unit. The gas intake unit may be operable to draw atmospheric air through the gas inlet and into the gas generation apparatus. The gas intake unit may be operable to draw gas through the gas inlet and into the gas generation apparatus. The gas intake unit may be operable to draw compressed gas through the gas inlet and into the gas generation apparatus.

The gas inlet may be configured to allow cooled atmospheric air to enter the apparatus. The gas inlet may be configured to allow compressed atmospheric air, or compressed gas, to enter the apparatus. The gas inlet may be configured to allow cooled compressed atmospheric air, or cooled compressed gas, to enter the apparatus. The compressed atmospheric air may be cooled compressed atmospheric air. The compressed gas may be cooled compressed gas.

The gas inlet may be configured to be supplied with atmospheric air. The gas inlet may be configured to be supplied with compressed atmospheric air. The gas inlet may be configured to be supplied with cooled, compressed atmospheric air.

The filter unit may be a fluid filter unit. The filter unit may be a vapour filter unit. The filter unit may be a fluid and vapour filter unit. The filter unit may be a fluid, vapour and particulate filter unit. The filter unit may be configured to remove fluid, vapour or particulates from compressed gas from the gas inlet. The filter unit may be configured to remove moisture, coarse particulates and fine particulates from compressed gas from the gas inlet.

The filter unit may include two or more filter components. Each filter component may include a predetermined filter characteristic. The filter unit may include three filter components. Each filter component may include a predetermined filter characteristic. The filter unit may include a plurality of filter components. Each filter component may include a predetermined filter characteristic.

The filter unit may include a first filter component. The first filter component may be configured to filter fluid from compressed gas. The first filter component may be configured to filter fluid, vapour and particulates from compressed gas. The first filter component may be configured to filter fluid in the form of liquid and/or vapour from compressed gas.

The filter unit may include a second filter component. The second filter component may be configured to filter coarse particulates from compressed gas. The coarse particulates may be mist or vapour.

The filter unit may include a third filter component. The third filter component may be configured to filter fine particulates from compressed gas. Fine particulates may be any material or substance larger than 0.1 Micron.

The fluid level control system may comprise two or more fluid level control control apparatuses. The fluid level control system may comprise two fluid level control apparatuses.

A first fluid level control apparatus may be configured to operate with the first filter component of the filter unit.

A second fluid level control apparatus may be configured to operate with the second filter component of the filter unit.

A third fluid level control apparatus may be configured to operate with the third filter component of the filter unit.

The gas processing apparatus may further comprise a gas separator. The gas separator may be configured to separate the compressed gas from the filter unit.

The gas separator may be configured to separate the gas into one or more components. The gas separator of the gas generation apparatus may be configured to separate out substantially all but one of the gas components of the compressed gas. The gas separator of the gas generation apparatus may be configured to selectively separate out substantially all but one of the gas components of the compressed gas.

Where the compressed gas is compressed atmospheric air, the gas separator may be configured to separate compressed atmospheric air from the filter unit into at least one of its constituent gas components. That is, the gas separator of the gas generation apparatus may be configured to separate out substantially all but one of the gas components of the atmospheric air. The gas separator of the gas generation apparatus may therefore be operable to selectively separate out four out of the five main gases present in atmospheric air. The remaining gas present after passing the compressed atmospheric air through the gas separator of the gas generation apparatus may therefore be nitrogen, oxygen, argon or carbon dioxide.

The gas separator of the gas generation apparatus may be a membrane filter. The gas separator of the gas generation apparatus may be a carbon molecular sieve filter. The gas separator of the gas generation apparatus may be a mol sieve filter. The gas separator of the gas generation apparatus may be a dryer membrane filter. The gas separator of the gas generation apparatus may be a hollow fibre membrane filter. The gas separator of the gas generation apparatus may be a molecular sieve. The gas separator of the gas generation apparatus may be a catalytic reactor. The gas separator may be a hydrocarbon molecular sieve. The gas separator may be a membrane. The gas separator may be a pressure swing adsorption (PSA) apparatus. The gas separator may be a vacuum pressure swing adsorption (VPSA) apparatus. The gas separator may be a catalytic reaction apparatus. The gas separator may be a thermal swing adsorption (TSA) apparatus. The gas separator may be an electrolysis apparatus. The gas separator may be a fractional distillation apparatus. The gas separator may be a chemical reaction apparatus.

The apparatus may further comprise a compressor unit, the compressor unit being operable to draw gas through a gas intake unit, or gas inlet, or inlet filter and into the compressor unit.

The filter unit may be configured to filter the compressed gas from the compressor unit.

The fluid level control system may be operable to control the level of fluid removed from the compressed gas by the filter unit.

The apparatus may further comprise a cooling unit. The cooling unit may be located between the compressor unit and the filter unit. The cooling unit may be a fin tube cooler, a cooling coil, or the like. The purpose of the cooling unit is to cool the compressed gas from the compressor unit.

The filter unit may be configured to remove fluid, vapour or particulates from the compressed gas from the compressor unit. The filter unit may be configured to remove moisture, coarse particulates and fine particulates from the compressed gas from the compressor unit.

The filter unit may include a first filter component. The first filter component may be configured to filter fluid from the compressed gas. The first filter component may be configured to filter fluid, vapour and particulates from the compressed gas. The first filter component may be configured to filter fluid in the form of liquid and/or vapour from the compressed gas.

The filter unit may include a second filter component. The second filter component may be configured to filter coarse particulates from the compressed gas. The coarse particulates may be mist or vapour.

The filter unit may include a third filter component. The third filter component may be configured to filter fine particulates from the compressed gas. Fine particulates may be any material or substance larger than 0.1 Micron.

The apparatus may further comprise a gas storage tank, the gas storage tank being configured to receive and store the separated compressed gas from the gas separator. The gas storage tank may be located between the gas separator and the separated gas outlet.

The second air filter unit of the gas generation apparatus may be configured to separate the compressed gas from the filter unit into at least one of its constituent gas components.

The separated gas outlet may be connectable to a gas output circuit.

The gas generation apparatus may comprise two or more compressor units. Each compressor unit may draw gas through a gas intake unit, or gas inlet, or inlet filter of the compressor unit. Alternatively, the gas generation apparatus may include two or more gas intake units, and each compressor may operate with its own gas intake unit. In this arrangement, each compressor unit includes its own filter unit, fluid level control system, gas separator and separated gas outlet. Each gas separator may be configured to separate a different constituent gas component from the gas. Each gas separator may be configured to separate the same constituent gas component from the gas.

The gas generation apparatus may include two or more compressor units, each compressor unit being configured to operate with a filter unit, a fluid level control system, a gas separator, and a separated gas outlet.

Embodiments of the fifteenth aspect of the present invention may include one or more features of the first, second, third, fourth, fifth sixth, seventh, eighth, ninth, tenth, eleventh, twelfth, thirteenth, or fourteenth aspects of the present invention or their embodiments. Similarly, embodiments of the first, second, third, fourth, fifth, sixth, seventh, eighth, ninth, tenth, eleventh, twelfth, thirteenth, or fourteenth aspects of the present invention may include one or more features of the fifteenth aspect of the present invention or its embodiments.

According to a sixteenth aspect of the present invention there is provided a method of processing gas comprising the steps of:
providing a gas processing apparatus comprising:
   a gas inlet, the gas inlet being configured to allow gas to enter the apparatus;
   a filter unit, the filter unit being configured to filter the gas from the gas inlet;
   a fluid level control system, the fluid level control system being operable to control the level of fluid removed from the gas by the filter unit, the fluid level control system comprising:
      a fluid level control apparatus comprising:
         a body portion having a fluid inlet and a fluid outlet;
         a first sensor module, the first sensor module being configured to sense fluid at a first position within the body portion;
         a second sensor module, the second sensor module being configured to sense fluid at a second position within the body portion; and
         a control module, the control module being configured to receive output signals from the first and second sensor modules, and send a fluid outlet valve control signal; and
      a fluid outlet valve;
   a gas outlet, the gas outlet being configured to receive the gas from the filter unit;
providing gas to the gas inlet;
filtering the gas from the gas inlet with the filter unit;
operating the fluid level control system to control the level of fluid removed from the gas by the filter unit; and
providing the gas to the gas outlet.

The gas intake unit may be an air intake unit.

The gas may be atmospheric air.

The gas processing apparatus may further comprise a gas separator. The gas separator may be configured to separate the compressed gas from the filter unit.

The gas processing apparatus may further comprise a compressor unit. The compressor unit may be configured to draw gas through the gas inlet into the compressor unit.

Embodiments of the sixteenth aspect of the present invention may include one or more features of the first, second, third, fourth, fifth sixth, seventh, eighth, ninth, tenth, eleventh, twelfth, thirteenth, fourteenth, or fifteenth aspects of the present invention or their embodiments. Similarly, embodiments of the first, second, third, fourth, fifth, sixth, seventh, eighth, ninth, tenth, eleventh, twelfth, thirteenth, fourteenth, or fifteenth aspects of the present invention may include one or more features of the sixteenth aspect of the present invention or its embodiments.

According to a seventeenth aspect of the present invention there is provided a gas processing apparatus comprising:
a gas inlet, the gas inlet being configured to allow gas to enter the apparatus;
a filter unit, the filter unit being configured to filter the gas from the gas inlet;
a valve apparatus, the valve apparatus being operable to drain fluid removed from the gas by the filter unit, the valve apparatus comprising:
   a valve; and
   a control module, the control module being configured to control the operation of the valve; and
a gas outlet, the gas outlet being configured to receive the gas from the filter unit.

The gas intake unit may be an air intake unit. The gas may be atmospheric air. The gas may be compressed gas. The gas may be compressed atmospheric air.

The gas processing apparatus may further comprise a gas separator. The gas separator may be configured to separate the compressed gas from the filter unit.

The gas processing apparatus may further comprise a compressor unit. The compressor unit may be configured to draw gas through the gas inlet into the compressor unit.

Embodiments of the seventeenth aspect of the present invention may include one or more features of the first, second, third, fourth, fifth sixth, seventh, eighth, ninth, tenth, eleventh, twelfth, thirteenth, fourteenth, fifteenth, or sixteenth aspects of the present invention or their embodiments. Similarly, embodiments of the first, second, third, fourth, fifth, sixth, seventh, eighth, ninth, tenth, eleventh, twelfth, thirteenth, fourteenth, fifteenth, or sixteenth aspects of the present invention may include one or more features of the seventeenth aspect of the present invention or its embodiments.

According to an eighteenth aspect of the present invention there is provided a method of processing gas comprising the steps of:
providing a gas processing apparatus comprising:
   a gas inlet, the gas inlet being configured to allow gas to enter the apparatus;
   a filter unit, the filter unit being configured to filter the gas from the gas inlet;
   a valve apparatus, the valve apparatus being operable to drain fluid removed from the gas by the filter unit, the valve apparatus comprising:
      a valve; and
      a control module, the control module being configured to control the operation of the valve; and
   a gas outlet, the gas outlet being configured to receive the gas from the filter unit;
providing gas to the gas inlet;
filtering the gas from the gas inlet with the filter unit;
operating the fluid level control system to control the level of fluid removed from the gas by the filter unit; and
providing the gas to the gas outlet.

Embodiments of the eighteenth aspect of the present invention may include one or more features of the first, second, third, fourth, fifth sixth, seventh, eighth, ninth, tenth, eleventh, twelfth, thirteenth, fourteenth, fifteenth, sixteenth, or seventeenth aspects of the present invention or their embodiments. Similarly, embodiments of the first, second, third, fourth, fifth, sixth, seventh, eighth, ninth, tenth, eleventh, twelfth, thirteenth, fourteenth, fifteenth, sixteenth, or seventeenth aspects of the present invention may include one or more features of the eighteenth aspect of the present invention or its embodiments.

According to a nineteenth aspect of the present invention there is provided a gas generation apparatus comprising:
a fluid inlet, the fluid inlet being configured to allow fluid to enter the apparatus;
a first fluid separator, the first fluid separator being configured to separate a gas from the fluid from the fluid inlet;
a second fluid separator, the second fluid separator being configured to separate a fluid from the gas from the first fluid separator;
a fluid level control system, the fluid level control system being operable to control the level of fluid removed from the gas by the second fluid separator, the fluid level control system comprising:
   a fluid level control apparatus comprising:
      a body portion having a fluid inlet and a fluid outlet;
      a first sensor module, the first sensor module being configured to sense fluid at a first position within the body portion;
      a second sensor module, the second sensor module being configured to sense fluid at a second position within the body portion; and
      a control module, the control module being configured to receive output signals from the first and second sensor modules, and send a fluid outlet valve control signal; and
   a fluid outlet valve; and
a gas outlet, the gas outlet being configured to receive gas from the second fluid separator.

The fluid entering the fluid inlet may be water. The water may be deionised water. The water may be pressurised water. The water may be pressured deionised water.

The fluid entering the fluid inlet may be gravity-fed. The fluid entering the fluid inlet may be pumped. The fluid entering the fluid inlet may be from a pumped source.

The fluid inlet may be a water inlet. The fluid inlet may be configured to allow water to enter the apparatus. The water may be deionised water.

The first fluid separator may be configured to separate wet gas from the fluid from the fluid inlet. The gas separated from the fluid by the first fluid separator may be a wet gas. That is, the gas separated from the fluid by the first fluid separator may contain water vapour, water moisture, water particles, or the like.

The fluid inlet may be configured to allow water to enter the apparatus, and the first fluid separator may be configured to separate hydrogen from the water from the fluid inlet. The hydrogen may be wet hydrogen. The hydrogen may contain water vapour, water moisture, water particles, or the like.

The first fluid separator may be configured to separate the fluid from the fluid inlet into a liquid component and two gaseous components. The first fluid separator may be configured to separate water from the fluid inlet into a water, hydrogen and oxygen. The separated hydrogen may be wet hydrogen. The separated hydrogen may contain water vapour, water moisture, water particles, or the like.

The first fluid separator may include an electrolysis cell. The first fluid separator may include a proton-exchange membrane (PEM) cell. The first fluid separator may include a fuel cell. The first fluid separator may include an alkaline fuel cell (AFC). The first fluid separator may include a solid oxide fuel cell.

The first fluid separator may be a liquid separator.

The second fluid separator may be configured to separate a liquid from the gas from the first fluid separator. The second fluid separator may be configured to separate water from the gas from the first fluid separator.

The second fluid separator may be configured to separate water from the hydrogen from the first fluid separator. The second fluid separator may be configured to remove water, water vapour, water particles, or the like, from the gas from the first fluid separator.

The second fluid separator may be a vapour-removal apparatus, water-removal apparatus, or water moisture-removal apparatus.

The gas produced by the second fluid separator may have a lower water content than the gas suppled to the second fluid separator.

The gas outlet may be configured to receive hydrogen gas from the second fluid separator.

The gas generation apparatus may further comprise a deionising apparatus. The deionising apparatus may be located between the fluid inlet and the first fluid separator. The deionising apparatus may be configured to deionise the fluid entering the apparatus.

The gas generation apparatus may further comprise a fluid pump. The fluid pump may be operable to pump fluid from the fluid inlet to the first fluid separator. The fluid pump may be located between the fluid inlet and the first fluid separator.

The gas generation apparatus may further comprise one or more gas drying apparatuses. The one or more gas drying apparatuses may be located between the second fluid separator and the gas outlet. The one or more gas drying apparatuses may be configured to dry, or further dry, the gas from the second fluid separator.

Embodiments of the nineteenth aspect of the present invention may include one or more features of the first, second, third, fourth, fifth sixth, seventh, eighth, ninth, tenth, eleventh, twelfth, thirteenth, fourteenth, fifteenth, sixteenth, seventeenth, or eighteenth aspects of the present invention or their embodiments. Similarly, embodiments of the first, second, third, fourth, fifth, sixth, seventh, eighth, ninth, tenth, eleventh, twelfth, thirteenth, fourteenth, fifteenth, sixteenth, seventeenth, or eighteenth aspects of the present invention may include one or more features of the nineteenth aspect of the present invention or its embodiments.

According to a twentieth aspect of the present invention there is provided a method of generating gas comprising the steps of:
providing a gas generation apparatus comprising:
   a fluid inlet, the fluid inlet being configured to allow fluid to enter the apparatus;
   a first fluid separator, the first fluid separator being configured to separate a gas from the fluid from the fluid inlet;
   a second fluid separator, the second fluid separator being configured to separate a fluid from the gas from the first fluid separator;
   a fluid level control system, the fluid level control system being operable to control the level of fluid removed from the gas by the second fluid separator, the fluid level control system comprising:
      a fluid level control apparatus comprising:
         a body portion having a fluid inlet and a fluid outlet;
         a first sensor module, the first sensor module being configured to sense fluid at a first position within the body portion;
         a second sensor module, the second sensor module being configured to sense fluid at a second position within the body portion; and
         a control module, the control module being configured to receive output signals from the first and second sensor modules, and send a fluid outlet valve control signal; and
      a fluid outlet valve; and
   a gas outlet, the gas outlet being configured to receive gas from the second fluid separator,
providing a fluid to the fluid inlet;
separating the fluid from the fluid inlet with the first fluid separator;
separating the gas from the first fluid separator with the second fluid separator;
operating the fluid level control apparatus to control the level of fluid removed from the gas by the second fluid separator; and
providing the gas from the second fluid separator to the gas outlet.

The fluid entering the fluid inlet may be water. The water may be deionised water. The water may be pressurised water. The water may be pressured deionised water.

The fluid entering the fluid inlet may be gravity-fed. The fluid entering the fluid inlet may be pumped. The fluid entering the fluid inlet may be from a pumped source.

The fluid inlet may be a water inlet. The fluid inlet may be configured to allow water to enter the apparatus. The water may be deionised water.

The first fluid separator may be configured to separate wet gas from the fluid from the fluid inlet. The gas separated from the fluid by the first fluid separator may be a wet gas. That is, the gas separated from the fluid by the first fluid separator may contain water vapour, water moisture, water particles, or the like.

The fluid inlet may be configured to allow water to enter the apparatus, and the first fluid separator may be configured to separate hydrogen from the water from the fluid inlet. The hydrogen may be wet hydrogen. The hydrogen may contain water vapour, water moisture, water particles, or the like.

The first fluid separator may be configured to separate the fluid from the fluid inlet into a liquid component and two gaseous components. The first fluid separator may be configured to separate water from the fluid inlet into a water, hydrogen and oxygen. The separated hydrogen may be wet hydrogen. The separated hydrogen may contain water vapour, water moisture, water particles, or the like.

The first fluid separator may include an electrolysis cell. The first fluid separator may include a proton-exchange membrane (PEM) cell. The first fluid separator may include a fuel cell. The first fluid separator may include an alkaline fuel cell (AFC). The first fluid separator may include a solid oxide fuel cell.

The first fluid separator may be a liquid separator.

The second fluid separator may be configured to separate a liquid from the gas from the first fluid separator. The second fluid separator may be configured to separate water from the gas from the first fluid separator. The second fluid separator may be configured to separate water from the hydrogen from the first fluid separator. The second fluid separator may be configured to remove water, water vapour, water particles, or the like, from the gas from the first fluid separator.

The second fluid separator may be a vapour-removal apparatus, water-removal apparatus, or water moisture-removal apparatus.

The gas produced by the second fluid separator may have a lower water content than the gas suppled to the second fluid separator.

The gas outlet may be configured to receive hydrogen gas from the second fluid separator.

The gas generation apparatus may further comprise a deionising apparatus. The deionising apparatus may be located between the fluid inlet and the first fluid separator. The deionising apparatus may be configured to deionise the fluid entering the apparatus.

The gas generation apparatus may further comprise a fluid pump. The fluid pump may be operable to pump fluid from the fluid inlet to the first fluid separator. The fluid pump may be located between the fluid inlet and the first fluid separator.

The gas generation apparatus may further comprise one or more gas drying apparatuses. The one or more gas drying apparatuses may be located between the second fluid separator and the gas outlet. The one or more gas drying apparatuses may be configured to dry, or further dry, the gas from the second fluid separator.

Embodiments of the twentieth aspect of the present invention may include one or more features of the first, second, third, fourth, fifth sixth, seventh, eighth, ninth, tenth, eleventh, twelfth, thirteenth, fourteenth, fifteenth, sixteenth, seventeenth, eighteenth, or nineteenth aspects of the present invention or their embodiments. Similarly, embodiments of the first, second, third, fourth, fifth, sixth, seventh, eighth, ninth, tenth, eleventh, twelfth, thirteenth, fourteenth, fifteenth, sixteenth, seventeenth, eighteenth, or nineteenth aspects of the present invention may include one or more features of the twentieth aspect of the present invention or its embodiments.

### BRIEF DESCRIPTION OF THE DRAWINGS

Embodiments of the invention will now be described, by way of example, with reference to the drawings, in which:

FIG. 1 is a schematic view of an example gas generation apparatus;

FIG. 2 is a schematic view of an example alternative gas generation apparatus;

FIG. 3 is a schematic view of an example further alternative gas generation apparatus;

FIG. 4 is a schematic view of an example further alternative gas generation apparatus;

FIG. 5 is a perspective side view of a fluid level control apparatus in accordance with the present invention;

FIG. 6 is an exploded view of the fluid level control apparatus of FIG. 5;

FIG. 7 is a schematic view of multiple fluid level control systems in accordance with the present invention, including multiple fluid level control apparatuses of FIG. 5, in use with a filter unit of a gas generation apparatus/gas processing apparatus of the present invention;

FIG. 8 is a schematic view of multiple fluid level control systems in accordance with the present invention, including multiple fluid level control apparatuses of FIG. 5, in use with a filter unit of an alternative gas generation apparatus/gas processing apparatus of the present invention;

FIG. 9 is a schematic view of a gas generation apparatus/gas processing apparatus in accordance with the present invention;

FIG. 10 is a schematic view of an alternative gas generation apparatus/gas processing apparatus in accordance with the present invention;

FIG. 11 is a schematic view of a further alternative gas generation apparatus/gas processing apparatus in accordance with the present invention;

FIG. 12 is a schematic view of a further alternative gas generation apparatus/gas processing apparatus in accordance with the present invention;

FIG. 13 is a schematic view of a fluid level control system in accordance with the present invention;

FIG. 14 is a schematic view of a valve apparatus in accordance with the present invention;

FIG. 15 is a schematic view of a further alternative gas generation apparatus/gas processing apparatus in accordance with the present invention;

FIG. 16 is a schematic view of a further alternative gas generation apparatus/gas processing apparatus in accordance with the present invention;

FIG. 17 is a schematic view of a further alternative gas generation apparatus/gas processing apparatus in accordance with the present invention;

FIG. 18 is a schematic view of a further alternative gas generation apparatus/gas processing apparatus in accordance with the present invention;

FIG. 19 is a schematic view of an alternative gas generation apparatus; and

FIG. 20 is a schematic view of a gas generation apparatus in accordance with the present invention.

### DESCRIPTION OF PREFERRED EMBODIMENTS

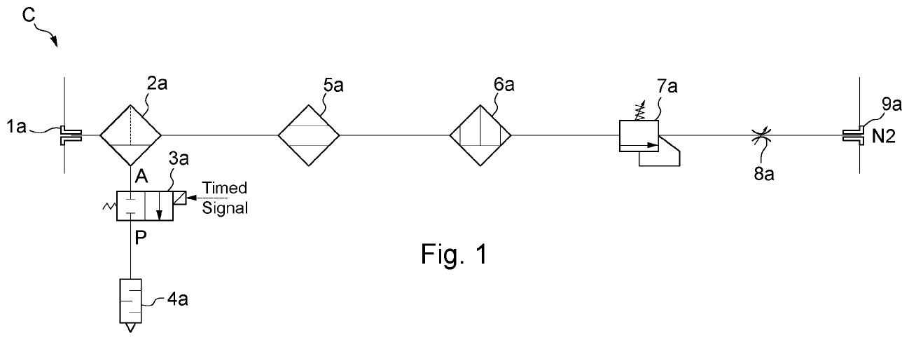

FIGS. 1 to 4 are schematic examples of known gas generation apparatuses. In the examples illustrated here, the apparatuses generate nitrogen gas from atmospheric air. The atmospheric air may be supplied to the gas generation apparatus, or the gas generation apparatus may include one or more compressor units. However, other gas generation apparatuses are known to generate other gases, or gas mixtures, and may include more than two compressors.

The operation of such gas generation apparatuses is well understood and no detailed explanation of the operation of the apparatuses will be provided here.

The gas generation apparatus C of FIG. 1 includes the following components:

1a Inlet Bulkhead
2a Filter - Water/Mist
3a Solenoid Drain Valve (Timed Drain)
4a Silencer
5a Membrane Filter
6a Particulate Filter
7a Pressure Regulator
8a Flow Controller
9a Outlet Bulkhead

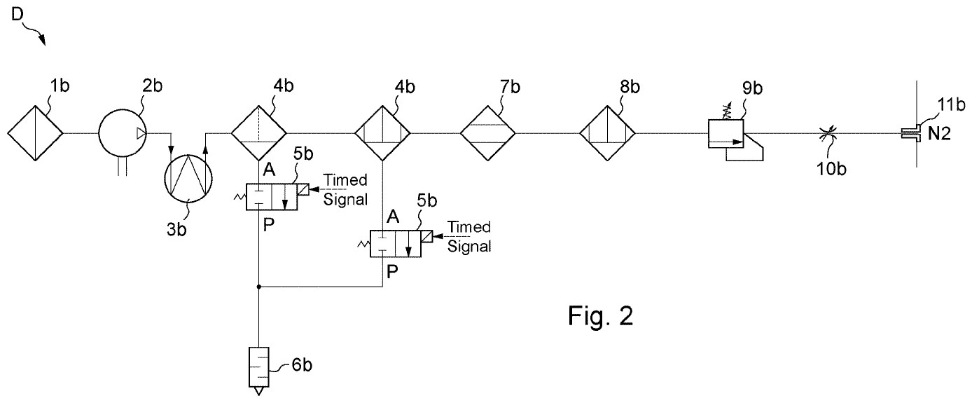

The gas generation apparatus D of FIG. 2 includes the following components:

1b Compressor Inlet Filter
2b Compressor
3b Cooler
4b Filter - Water/Mist
5b Solenoid Drain Valve (Timed Drain)
6b Silencer
7b Membrane Filter
8b Particulate Filter
9b Pressure Regulator
10b Flow Controller
11b Output Bulkhead

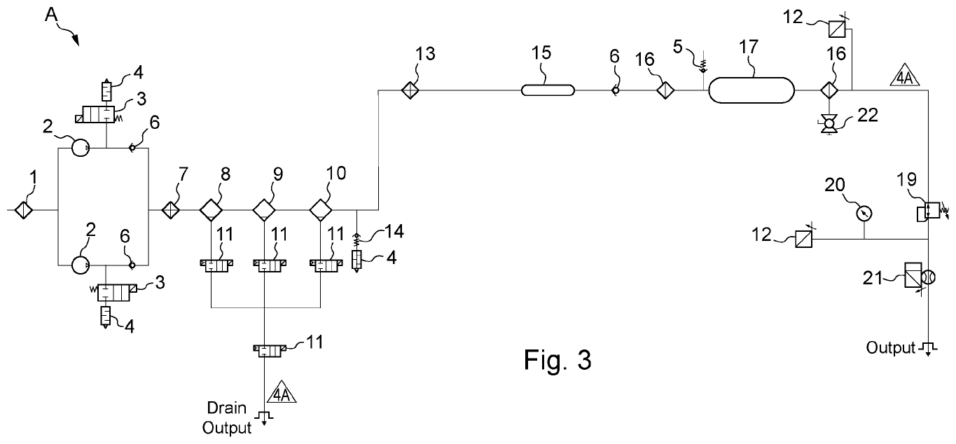

The gas generation apparatus A of FIG. 3 includes the following components:

1. Inlet filter
2. Compressor
3. Compressor offload valve
4. Silencer
5. Safety relief valve
6. Non-return valve
7. Fin tube cooler
8. Water separator
9. Coarse particulate filter
10. Fine particulate filter
11. Drain valve
12. Pressure transducer
13. Re-heat coil
14. Back pressure relief valve
15. Nitrogen membrane
16. Hydrocarbon tower filter
17. Nitrogen storage tank
18. Fine particulate filter
19. Output pressure regulator
20. Output pressure gauge
21. Flow transducer
22. Manual ball valve

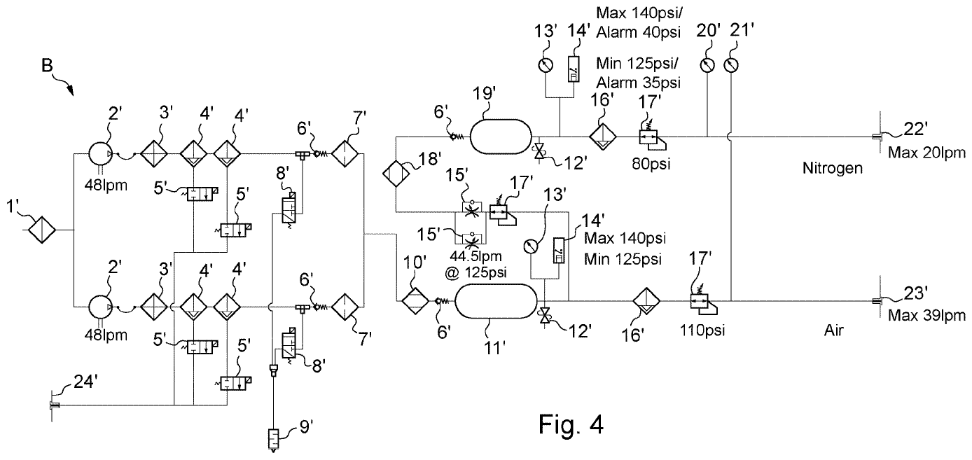

The gas generation apparatus B of FIG. 4 includes the following components:

1′. Compressor inlet filter
2′. Compressor
3′. Cooling coil
4′. Duplex filter
5′. N/C Solenoid drain valve
6′. Non-return valve
7′. Re-heating coil
8′. N/O Solenoid offloader valve
9′. Vent silencer
10′. Dryer membrane
11′. Storage tank
12′. Safety relief valve
13′. Pressure gauge (tank)
14′. Pressure switch
15′. Mass Flow controller
16′. RAC Filter
17′. Pressure regulator
18′. Nitrogen membrane
19′. Storage tank
20′. Pressure gauge (Nitrogen)
21′. Pressure gauge (Air)
22′. Outlet port (Nitrogen)
23′. Outlet port (Air)
24′. Outlet port (Drain)

The main difference between the apparatuses of FIG. 1 and FIG. 2 is that the apparatus of FIG. 1 does not include a compressor unit and includes a single water/mist filter 2a, whereas the apparatus of FIG. 2 includes a compressor unit 2b, a cooler 3b and a two stage water/mist filter 4b. With the apparatus C of FIG. 1 compressed air may be supplied to the inlet bulkhead 1a by external apparatus.

The main difference between the apparatuses of FIG. 3 and FIG. 4 is that the apparatus A of FIG. 3 filters the compressed air from both compressor units 2 through a triplex filtration system 8, 9 and 10, whereas the apparatus B of FIG. 4 filters the compressed air from each compressor 2′ via a duplex filtration system 4′.

As is known with such gas generation apparatuses, the purity of the gas generated by the apparatus is dependent on the pressure, temperature and density of the compressed air that is filtered. If the pressure of the compressed air supplied to the filters 5a, 7b, 15, 18′ drops, then the flow rate of the compressed air through the gas filter is reduced, which affects the purity of the generated gas.

As is also known, it is necessary to drain extracted water, or moisture, from the filters 2a, 4b, triplex filter 8, 9 and 10 and duplex filter 4′. This is carried out through operation of drain valves 3a, 5b, 11 and 5′. If the water is not drained from the filters 2a, 4b, 8, 9, 10 and 4′, then severe damage may occur to components of the apparatus C, D, A, B, notably the nitrogen membrane filters 5a, 7b, 15, 18′, which is an example of a gas separation apparatus. It is also possible that the gas generated by the apparatus could contain an unacceptable level of water, or water vapour, which could damage further apparatuses to which the gas is supplied.

As stated above, the inventors of the present invention have appreciated the shortcomings with such known gas generation apparatuses C, D, A, B.

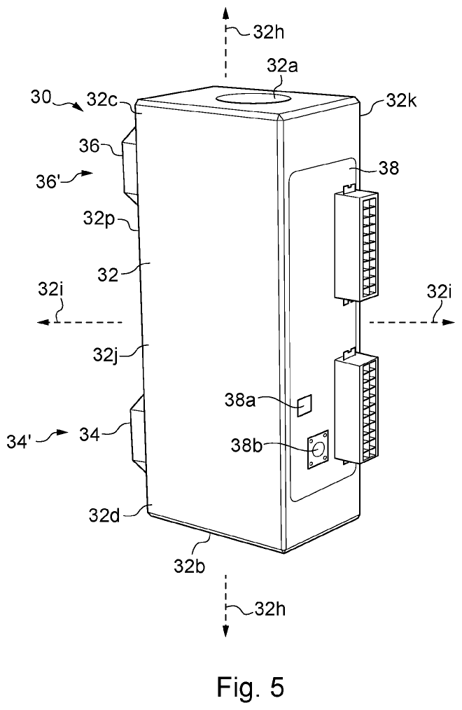

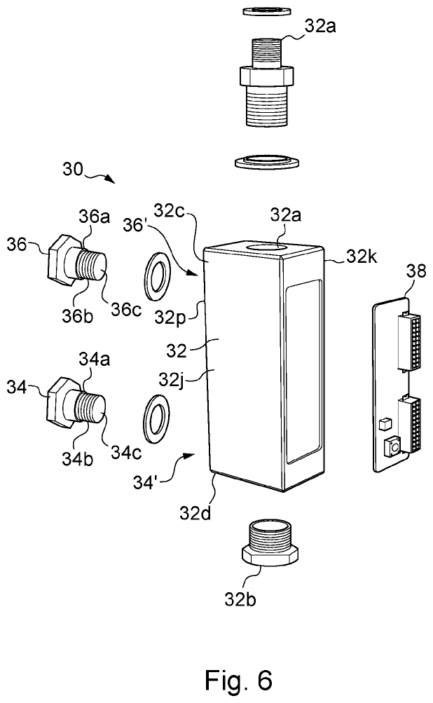

With reference to FIGS. 5 and 6, a fluid level control apparatus 30 is illustrated. As described further below, the fluid level control apparatus 30 may be used as part of a fluid level control system 30′ (fluid control apparatus 30 and fluid outlet valve 40) of a filter unit 300, 300′ of a gas generation apparatus/gas processing apparatus C′, D′, A′, B′ of the present invention.

The fluid level control apparatus 30 includes a body portion 32 having a fluid inlet 32a and a fluid outlet 32b, a first sensor module 34, a second sensor module 36 and a control module 38. The apparatus 30 is configured to be operable with a fluid outlet valve 40, as described further below. The fluid outlet valve 40 is configured to control the flow of water out of the body portion 32 of the apparatus 30.

In use, the body portion 32 is arranged to receive water, or water vapour at the fluid inlet 32a from a filter unit 300, 300′ of a gas generating apparatus/gas processing apparatus C′, D′ A′, B′. With the fluid outlet valve 40 closed, the body portion 32 may fill with water, or condensed water.

The fluid inlet 32a is located on an upper portion 32c of the body portion 32 and the fluid outlet 32b is located on a lower portion 32d of the body portion 32. The fluid outlet valve 40 is fluidly connected to the fluid outlet 32b of the body portion 32.

Typically, the volume of the body portion 32 may be between 4 ml and 12 ml. In the embodiment illustrated and described here, the volume of the body portion 32 is 8 ml. However, it should be appreciated that other sizes and volumes are possible. Volumes of the body portion 32 of up to 11 are possible, depending on the operating parameters of the system.

The body portion 32 includes a longitudinal axis 32h and a lateral axis 32i. The longitudinal axis 32h extends between the upper portion 32c and the lower portion 32d of the body portion 32. The lateral axis 32i extends between a left side 32j and a right side 32k of the body portion 32.

The first sensor module 34 is configured to sense fluid at a first position 34′ within the body portion 32, and the second sensor module 36 is configured to sense fluid at a second position 36′ within the body portion 32. As best illustrated in FIG. 3, the first and second sensor modules 34, 36 are located on a rear side 32p of the body portion 32. The first sensor module 34 is located towards the lower portion 32d of the body portion 32, and the second sensor module 36 is located towards the upper portion 32c of the body portion 32.

In the embodiment illustrated and described here, the sensor modules 34, 36 are optical sensors. Each sensor module 34, 36 includes a light emitter 34a, 36a, which may be a light emitting diode (LED), a reflecting prism 34c, 36c, and a light detector 34b, 36b, which may be a photodiode.

The light emitting and detecting part or each sensor module 34, 36 protrude into the body portion 32, such that they can come into contact, and be covered by, fluid in the body portion during use.

Each sensor module 34, 36 is operable to output an electrical signal that is a function of the amount of light detected at the light detector 34b, 36b.

The output signals from the sensor modules 34, 36 may be termed fluid level signals, as they are representative of the presence of fluid (water) at the position of the sensor 34, 36.

In the embodiment illustrated and described here, the light emitter 34a, 36a and light detector 34b, 36b of each sensor module 34, 36 emits and detects light between 780 nm and 1 mm. However, it should be appreciated that other wavelengths in the electromagnetic spectrum are possible.

As described further below, the control module 38 is operable to monitor the output of the sensor modules 34, 36 and control the fluid outlet valve 40. The control module 38 does this by receiving the fluid level signals from each sensor module 34, 36 and sending a fluid outlet valve control signal to the fluid outlet valve 40, as appropriate. The fluid outlet valve control signal effects the operation of the fluid outlet valve 40, which allows water to be drained from the body portion 32 of the fluid level control apparatus 30.

The control module 38 is operable to control the following operating parameters of the fluid outlet valve 40: the amount that the valve is opened; the flow rate of water through the valve, the length of time that the valve is open, the frequency which the valve is opened and closed etc.

In the embodiment illustrated and described here, the fluid outlet valve 40 is a solenoid valve, and the control module 38 is operable to open and close the valve 40 at periods between 20 ms and 50 ms at a time, i.e., the control module 38 may be operable to open and close the valve utilising a variable pulse. The variable pulse may be determined by the time taken for the second sensor 36 to detect fluid and no fluid. The pulse period may then be fixed during a cycle. The pulse period may vary dependent on the amount of fluid present/condensed. The control module 38 may use pulse width modulation (PWM) to operate the opening and closing of the valve 40.

The control module 38 is attached to the body portion 32, as illustrated in FIG. 5. However, it should be appreciated that the control module 38 may have an alternative location and/or be separate from the body portion 32.

In the embodiment illustrated and described here, the control module 38 includes a micro controller (MC) on a printed circuit board (PCB), which is programmed to control the operation of the sensor modules 34, 36 and the fluid outlet valve 40. The MC may include a power supply module, an input/output (I/O) module, a processor module, and a programming module. The control module 38 may be operable from a 24v/0.1 A DC power source. It should be appreciated that types of control modules with alternative control components and/or systems may be used.

The control module 38 is also programmable to output one or more alarm signals which may be indicative of an unexpected, or undesirable, operating condition of the apparatus 30. The one or more alarm signals may be audible, visual, electronic, or the like. The alarm signal may be a signal which indicates that fluid remains present in the body portion 32 when it should not be. That is, fluid remains in the body portion 32 after the draining operation of the valve 40. Two or more control modules 38 may be linked, such that the operation of each of the fluid level control apparatuses 30 may be controlled. In this arrangement, if one control module 38 receives a signal which is indicative of an unexpected, or undesirable, operating condition, the operation of gas generation apparatus may be halted until the problem is cleared.

The control module 38 also includes an apparatus status indication device, which in the embodiment illustrated and described here is an LED 38a. The apparatus status indication device 38a may be configured to indicate a status, or an operating condition of the apparatus 30, and it may be configured to output one or more visual signals and/or audible signals.

In the embodiment illustrated and described here, the fluid outlet valve 40 is an electronically-controlled valve, such as a solenoid valve. As described above, the fluid outlet valve 40 is controlled by the control module 38.

In the embodiment illustrated and described here, the fluid outlet valve 40 is a separate component to the apparatus 30. However, it should be appreciated that it may be formed with the body portion 32, for example.

Operation of the fluid level control apparatus 30 will now be described with reference to FIGS. 5, 6, and 7 to 12.

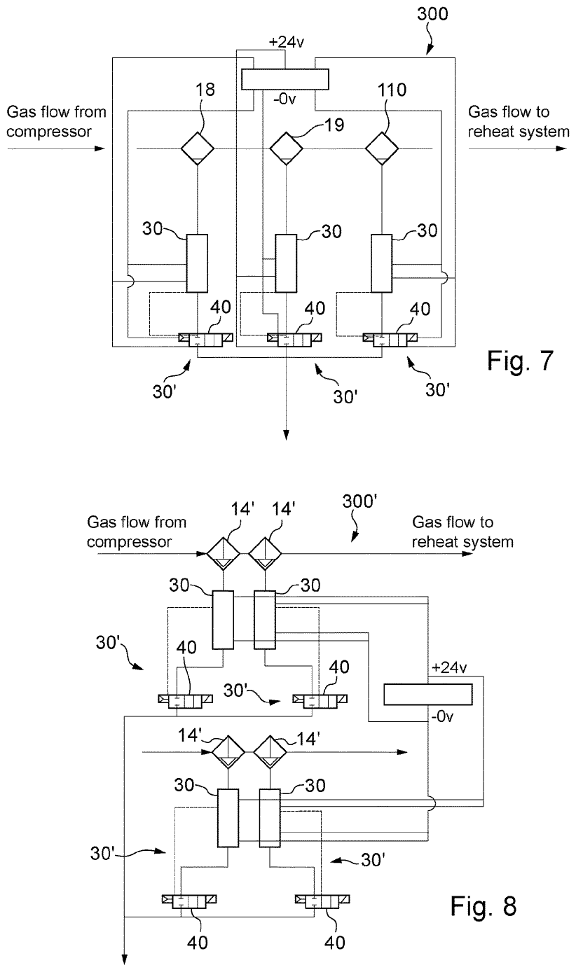

FIGS. 7 and 8 show multiple fluid level control apparatuses 30 in use with a filter unit 300,300′ of a gas generation apparatus/gas processing apparatus A′, B′. In the arrangement of FIG. 7, each apparatus 30 is connected to a filter component 18, 19 and 110, and has a corresponding fluid outlet valve 40. The filter components of FIG. 7 form part of a triplex filter unit, having a water separator 18 (an example of a first filter component), a coarse particulate filter 19 (an example of a second filter component), and a fine particulate filter 110 (an example of a third filter component). The filter unit 300 of a gas generation apparatus/gas processing apparatus A′ includes the filter components 18, 19, 110. In the arrangement of FIG. 8, each apparatus 30 is connected to a filter component 14′, and has a corresponding fluid outlet valve 40. The filter components 14′ of FIG. 6 form part of a duplex filter unit, having two filter components.

The fluid level control apparatus 30 can be fully autonomous, or can be integrated with a control system of the gas generation apparatus/gas processing apparatus. Furthermore, each fluid level control apparatus 30 can be connected in series (“daisy-chained”) to operate up to five, or more, separate units. Also, if the fluid level control apparatus 30 is integrated into the control system of the gas generation apparatus, then only one control module 38 is needed to operate the fluid outlet valves 40.

In the embodiment illustrated and described here, the gas generation apparatuses/gas processing apparatuses C′, D′, A′, B′, G, H, I, J is described as using atmospheric air as the input gas. However, it should be appreciated that the gas generation apparatuses/gas processing apparatuses C′, D′, A′, B′, G, H, I, J may be used with other types of gases.

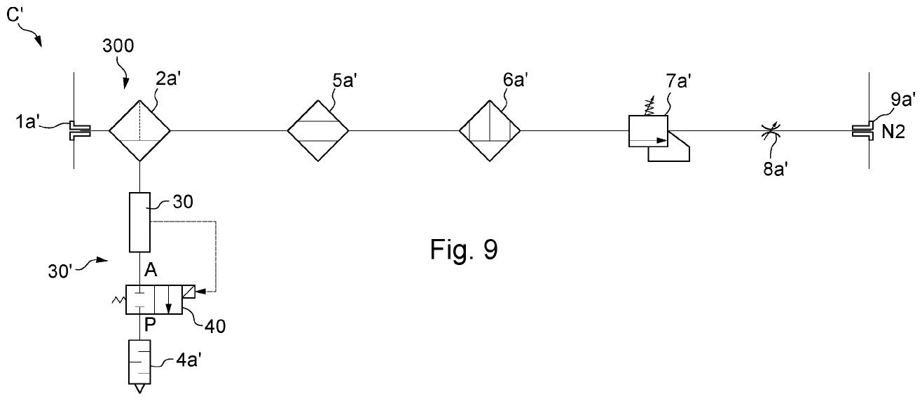

With reference to FIG. 9, the operation of gas generation apparatus/gas processing apparatus C′ will now be described.

Prior to supplying compressed atmospheric air to the inlet bulkhead (an example of an air inlet, or a gas inlet) 1a′, the fluid level control apparatus 30 is powered on and the control module 38 opens the fluid outlet valve 40 to release any pressure upstream thereof to atmosphere. This may be done for approximately 20 seconds. Once this is complete, compressed atmospheric air may be supplied to the inlet bulkhead 1a′ to flush any water out of the apparatus C′. The fluid outlet valve 40 is then closed and operation of the control module 38 begins.

Compressed air from the inlet bulkhead 1a′ then enters the water/mist filter (an example of a filter unit) 2a′.

The water/mist filter 2a′ is configured to remove water and/or water vapour from the compressed atmospheric air. This type of filter may be termed an ‘air dryer’.

As the compressed atmospheric air is passed through the filter 2a′, filtered water, or condensed water vapour, is fed by gravity into the fluid inlet 32a of the body portion 32 of the fluid level control apparatus 30.

The output from the filter 2a′ is compressed atmospheric air with a reduced water, or water vapour, content. This compressed atmospheric air then enters the nitrogen membrane/membrane filter 5a′ (an example of a gas separator).

The nitrogen membrane 5a′ (an example of a gas separation apparatus, or gas separator) is configured to separate out the majority of constituent atmospheric gas components from the compressed atmospheric air except nitrogen. It should be appreciated that other types of gas separators of the gas generation apparatus C′ may be carbon molecular sieve filters, or mol sieve filters, catalytic reactors, molecular sieves, or the like. The gas separator may be a hydrocarbon molecular sieve.

Nitrogen gas from the nitrogen membrane filter 5a′ may ultimately be passed to the outlet bulkhead 9a′ (an example of a separated gas outlet, or gas outlet).

As illustrated in FIG. 9, the gas generation apparatus/gas processing apparatus C′ comprises a number of other components that are used to operate the system. These components are well understood in the operation of gas generation apparatuses/gas processing apparatuses and no further explanation of their operation will be provided here. The gas generation apparatus/gas processing apparatus C′ of FIG. 9 includes the following components:

1a′ Inlet Bulkhead
2a′ Filter - Water/Mist
4a′ Silencer
5a′ Membrane Filter
6a′ Particulate Filter
7a′ Pressure Regulator
8a′ Flow Controller
9a′ Outlet Bulkhead

Continued operation of the gas generation apparatus/gas processing apparatus C′ results in a build-up of water in the fluid level control apparatus 30.

The control module 38 is programmed to expect the fluid level signal output from the first sensor module 34 to change between a first signal, which is indicative of no water at the sensor 34, to a second signal, which is indicative of water at the sensor 34, after the apparatus C′ begins to operate, as the water needs to build up in the body portion 32.

As the gas generation apparatus/gas processing apparatus C′ continues to operate, water rises in the body portion 32 until it reaches the second sensor module 36. At this point the control module 38 receives a fluid level signal from the second sensor 36 which indicates that the water in the body portion has reached the second sensor module 36.

The control module 38 then sends the fluid outlet valve control signal to the fluid outlet valve 40. The fluid outlet valve control signal actuates the fluid outlet valve 40. The signal that the control module 38 sends to the fluid outlet valve 40 is such that the valve 40 can be opened and closed. The control module 38 may be operable to open and close the valve 40 utilising a variable pulse. The variable pulse may be determined by the time taken for the second sensor 36 to detect fluid and no fluid. The pulse period may then be fixed during a cycle. The pulse period may vary dependent on the amount of fluid present/condensed.

The control module 38 may be operable to pulse the opening and closing of the valve 40 at one or more predetermined intervals dependent on one or more system conditions of the gas generation apparatus C′.

The control module 38 actuates the fluid outlet valve 40 in this manner until the fluid level in the body portion 32 decreases to the point that the first sensor module 34 no longer detects water. At this point the control module 38 ceases to actuate the fluid outlet valve 40, and the fluid in the body portion 32 begins to rise again with continued operation of the apparatus C′. This operation cycle repeats until the gas generation apparatus C′ is powered off.

The fluid level control apparatus 30 is therefore configured to operate automatically in dependence on the fluid level signals received from the first and second sensor modules 34, 36, and control the water level in the body portion 32.

Further detail of the operation of the fluid level control apparatus 30 is as follows:

### Power on:

(i) The fluid outlet valve 40 opens fully for 20 seconds. This removes the pressure from the system.
   a. To offload a system when powering off, the fluid level control apparatuses 30 are first unpowered and then powered again (so the valve 40 opens and vents). After 20 seconds the fluid level control apparatuses 30 auto-drains can be unpowered.

### Standby Mode:

(i) Standby means that second sensor 36 does not detect water. Blue LED is on.
   a. The first sensor 34 can be detecting water or not in this mode.

### Venting Mode:

(i) This mode is active when first and second sensors 34, 36 detect water for more than 60 seconds. LED colour changes to green.
   a. The 60 seconds waiting time prevents a spurious venting operation caused by small water droplets triggering temporarily the top sensor.
(ii) The valve 40 pulses a short amount of time, waits for 3 seconds and repeats the process.
   a. Opening the valve 40 creates a disturbance to the system that is dissipated after 3 seconds.
   b. The amount of time that the valve 40 pulses increases linearly in 1 millisecond intervals from 1 millisecond.
   c. Once the second sensor 36 does not detect water anymore, the pulsing time is kept until the first sensor 34 does not detect water neither.
   d. At this point, the fluid level control apparatus 30 goes into standby mode.
   e. If after venting 50 times the first sensor 34 still detects water, the time that the valve 40 vents is increased linearly again in 1 millisecond another 30 vent cycles.
   f. If water at the first sensor 34 stops being detected, fluid level control apparatus 30 goes immediately into standby mode. Otherwise, it goes into error mode.

### Error Mode

(i) This mode changes the LED colour to red. The fluid level control apparatus 30 does nothing in this mode.
   a. To leave error mode, the button 38b can be pressed or the fluid level control apparatus 30 can be power cycled.

### Button Press:

(i) When pressing the button 38b, besides clearing any errors the fluid level control apparatus 30 also vents during 100 milliseconds every 3 seconds.
(ii) If the button 38b is pressed for more than 10 seconds, a fault is created. This is useful for testing purposes.

### Daisy Chain:

(i) Every fluid level control apparatus 30 has an alarm-in and alarm-out ports.
   a. This line is 1 V if all the apparatuses 30 are operating normally.
   b. This line is 2 V if one apparatus 30 in the chain is in fault mode (except the last one).
   c. This line is 3 V is 2 or more apparatuses 30 (or the last apparatus 30) are in fault mode.
   d. Any number of apparatuses 30 can be daisy-chained.

As described above, the control module 38 may be operable to pulse the opening and closing of the valve 40 at one or more predetermined intervals. The control module 38 may be operable to pulse the opening and closing of the valve 40 at intervals dependent on one or more system conditions of the gas generation apparatus C′.

Draining the water from the fluid level control apparatus 30 in this manner does not significantly reduce the pressure in the gas generation apparatus/gas processing apparatus C′. This is because the apparatus 30 only operates to reduce the volume of water held in the body portion 32 during draining, not empty the body portion 32 entirely. Maintaining a volume of water between fluid outlet valve 40 and the position of the first sensor module 34 in the body portion 32 ensures that the only pressure drop introduced to the gas generation apparatus C′ during draining is as a result of the increase in volume added to the entire gas generation apparatus/gas processing apparatus C′ as a result of the water being drained between the position of the second sensor module 36 and the first sensor module 34 in the body portion 32. This change in volume represents a very small fraction of the overall volume of the gas generation apparatus/gas processing apparatus C′. Furthermore, rapidly opening and closing the fluid outlet valve 40 to drain the water from the body portion 32, means that there is no effective step change increase of volume to the apparatus C′, and the pressure change in the apparatus C′ is negligible.

If the fluid outlet valve 40 were to be simply opened to entirely drain the water from the body portion 32, then there would be a significant drop in the pressure in the gas generation apparatus/gas processing apparatus C′, as firstly there would be an increase in effective volume by the removal of all water from the body portion 32, and secondly, with all the water removed from the body portion 32 there is no fluid buffer, or fluid barrier, to prevent the compressed air escaping through the fluid outlet valve 40 from the apparatus C′. This would cause a significant decrease in the pressure of the apparatus C′.

If the apparatus C′ is powered off, the control module 38 actuates the fluid outlet valve 40 for approximately 5 seconds to release any pressure downstream thereof.

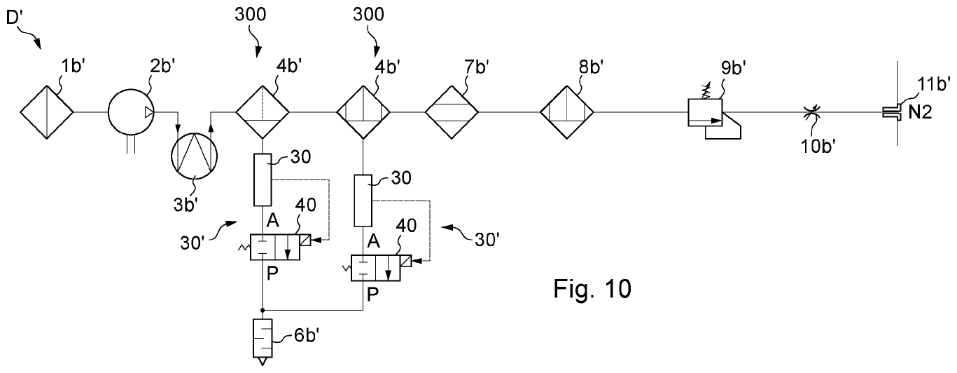

With reference to FIG. 10, the operation of a gas generation apparatus/gas processing apparatus D′ of the present invention will now be described.

Prior to starting the compressor 2b′ to generate gas, the fluid level control apparatuses 30 are powered on and the control modules 38 open the fluid outlet valves 40 to release any pressure upstream of the compressors 2b′ to atmosphere. This may be done for approximately 20 seconds. Once this is complete, compressors 2b′ are powered on to flush any water out of the apparatus D′. The fluid outlet valves 40 are then closed and operation of the control modules 38 begin.

Compressed air from the compressor inlet filter 1b′ (an example of an air inlet, or a gas inlet) is compressed by the compressor 2b′ and then cooled at the cooler 3b′ before entering the water/mist filters 4b′ (an example of a filter unit).

The water/mist filters 4b′ are configured to remove water and/or water vapour from the compressed atmospheric air. This type of filter may be termed an ‘air dryer’.

As the compressed atmospheric air is passed through each filter 4b′, filtered water, or condensed water vapour, is fed by gravity into the fluid inlets 32a of the body portion 32 of each fluid level control apparatus 30.

The output from the filters 4b′ is compressed atmospheric air with a reduced water, or water vapour, content. This compressed atmospheric air then enters the nitrogen membrane/membrane filter 7b′ (an example of a gas separator).

The nitrogen membrane 7b′ (an example of a gas separation apparatus) is configured to separate out the majority of constituent atmospheric gas components from the compressed atmospheric air except nitrogen. It should be appreciated that other types of gas separators of the gas generation apparatus/gas processing apparatus D′ may be carbon molecular sieve filters, or mol sieve filters, catalytic reactors, molecular sieves, or the like.

Nitrogen gas from the nitrogen membrane filter 7b′ may ultimately be passed to the outlet bulkhead 11b′ (an example of a separated gas outlet, or gas outlet).

As illustrated in FIG. 10, the gas generation apparatus/gas processing apparatus D′ comprises a number of other components that are used to operate the system. These components are well understood in the operation of gas generation apparatuses/gas processing apparatuses and no further explanation of their operation will be provided here. The gas generation apparatus/gas processing apparatus D′ of FIG. 10 includes the following components:

1b′ Compressor Inlet Filter
2b′ Compressor
3b′ Cooler
4b′ Filter - Water/Mist
6b′ Silencer
7b′ Membrane Filter
8b′ Particulate Filter
9b′ Pressure Regulator
10b′ Flow Controller
11b′ Output Bulkhead

The operation of the gas generation apparatus/gas processing apparatus D′ and each fluid level control apparatus 30 is substantially identical to that of the gas generation apparatus/gas processing apparatus C′.

Again, draining the water from each fluid level control apparatus 30 in the manner described above does not significantly reduce the pressure in the gas generation apparatus/gas processing apparatus D′.

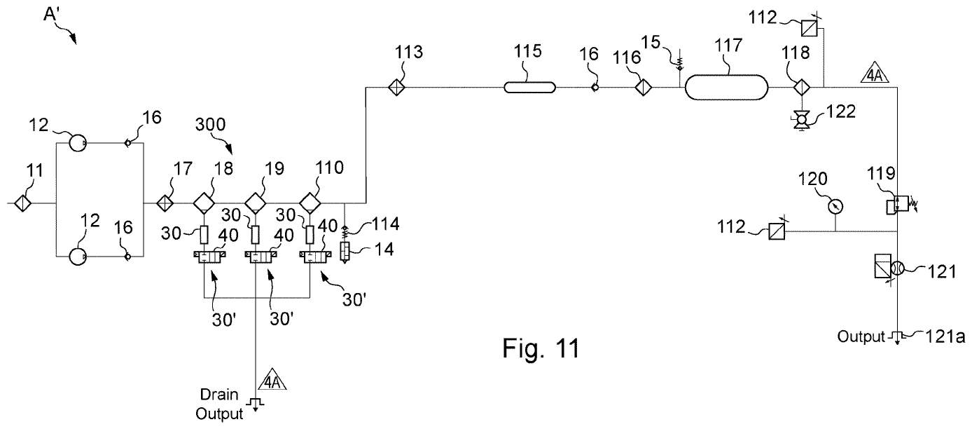

With reference to FIG. 11, the operation of a gas generation apparatus/gas processing apparatus A′ of the present invention will now be described.

Prior to starting the compressors 12 to generate gas, the fluid level control apparatuses 30 are powered on and the control modules 38 open the fluid outlet valves 40 to release any pressure upstream of the compressors 12 to atmosphere. This may be done for approximately 20 seconds. Once this is complete, compressors 12 are powered on to flush any water out of the apparatus A′. The fluid outlet valves 40 are then closed and operation of the control modules 38 begin.

Compressed air from the inlet filter 11 (an example of an air intake unit, or air inlet, or gas inlet) is compressed by the compressors 12 and then cooled at the fin tube cooler 17 before entering the triplex filter unit 18, 19 and 110 (an example of a filter unit).

The triplex filter unit 18, 19 and 110 is configured to remove water and/or water vapour from the compressed atmospheric air. This type of filter may be termed an ‘air dryer’.

As the compressed atmospheric air is passed through each filter 18, 19, and 110, filtered water, or condensed water vapour, is fed by gravity into the fluid inlets 32a of the body portion 32 of each fluid level control apparatus 30.

The output from the triplex filter unit 18, 19, 110 is compressed atmospheric air with a reduced water, or water vapour, content. This compressed atmospheric air is then heated by the re-heat coil 113 before entering the nitrogen membrane 115 (an example of a gas separator).

The nitrogen membrane 115 (an example of a gas separation apparatus) is configured to separate out the majority of constituent atmospheric gas components from the compressed atmospheric air except nitrogen. It should be appreciated that other types of gas separators of the gas generation apparatus/gas processing apparatus A′ may be carbon molecular sieve filters, or mol sieve filters, catalytic reactors, molecular sieves, or the like.

The nitrogen membrane filter 115 is connectable to a gas storage tank 117, which is configured to receive and store the separated compressed nitrogen gas therein. However, it should be appreciated that gas storage tank is not essential, and instead the nitrogen gas may be supplied directly to the output 121a (an example of a separated gas outlet, or gas outlet).

As illustrated in FIG. 11, the gas generation apparatus/gas processing apparatus A′ comprises a number of other components that are used to operate the system. These components are well understood in the operation of gas generation apparatuses/gas processing apparatuses and no further explanation of their operation will be provided here. The gas generation apparatus/gas processing apparatus A′ of FIG. 11 includes the following components:

11. Inlet filter
12. Compressor
14. Silencer
15. Safety relief valve
16. Non-return valve
17. Fin tube cooler
18. Water separator
19. Coarse particulate filter
110. Fine particulate filter
112. Pressure transducer
113. Re-heat coil
114. Back pressure relief valve
115. Nitrogen membrane
116. Hydrogen tower filter
117. Nitrogen storage tank
118. Fine particulate filter
119. Output pressure regulator
120. Output pressure gauge
121. Flow transducer
121a. Output/Separated gas outlet
122. Manual ball valve

The operation of the gas generation apparatus/gas processing apparatus A′ and each fluid level control apparatus 30 is substantially identical to that of the gas generation apparatuses/gas processing apparatuses C′ and D′.

Again, draining the water from each fluid level control apparatus 30 in the manner described above does not significantly reduce the pressure in the gas generation apparatus/gas processing apparatus A′.

If the apparatus A′ is powered off, the control module 38 actuates the fluid outlet valve 40 for approximately 5 seconds to release any pressure downstream of the compressors 12. This ensures that when the compressors 12 are next powered on, there is no pressure in the apparatus A′.

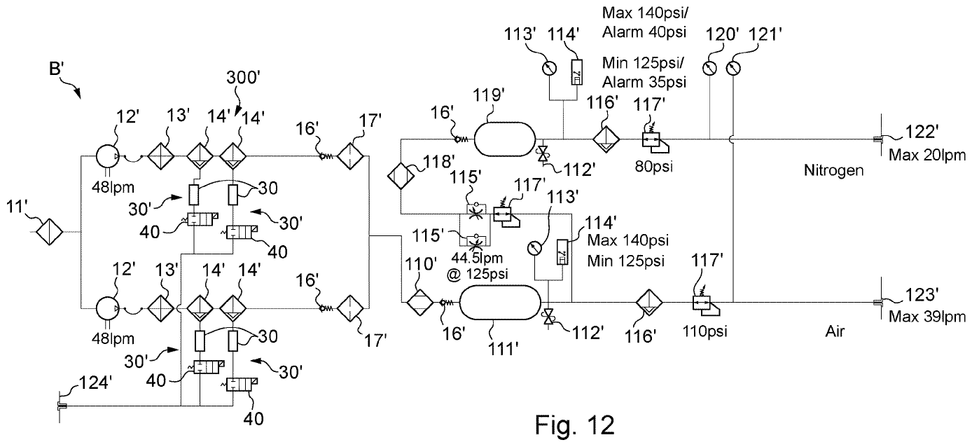

With reference to FIG. 12, the operation of a gas generation apparatus/gas processing apparatus B′ of the present invention will now be described.

Prior to starting the compressors 12′ to generate gas, the fluid level control apparatuses 30 are powered on and the control modules 38 open the fluid outlet valves 40 to release any pressure upstream of the compressors 12′ to atmosphere. This may be done for approximately 20 s. Once this is complete, compressors 12′ are powered on to flush any water out of the apparatus B′. The fluid outlet valves 40 are then closed and the control modules 38 run an initial calibration routine on each of the sensor modules 34, 36.

Compressed air from compressor inlet filter 11′ (an example of an air intake unit, air inlet, or a gas inlet) is compressed by each compressor 12′ and then cooled at the cooling coils 13′ before entering the duplex filters 14′ (an example of a filter unit).

The duplex filter units 14′ are configured to remove water and/or water vapour from the compressed atmospheric air. Again, this type of filter may be termed an ‘air dryer’.

As the compressed atmospheric air is passed through each filter 14′, filtered water, or condensed water vapour, is fed by gravity into the fluid inlets 32a of the body portion 32 of each fluid level control apparatus 30.

The output from each duplex filter unit 14′ is compressed atmospheric air with a reduced water, or water vapour, content. This compressed atmospheric air is then heated by the re-heat coil 17′ and combined before entering a dryer membrane 110′ and stored in a tank 111′. This compressed air may be output at outlet port 123′.

The compressed air also enters the nitrogen membrane 118′ (an example of a gas separator and a gas separation apparatus). The nitrogen membrane 118′ is configured to separate out the majority of constituent atmospheric gas components from the compressed atmospheric air except nitrogen. It should be appreciated that other types of gas separators of the gas generation apparatus/gas processing apparatus B′ may be carbon molecular sieve filters, or mol sieve filters, catalytic reactors, molecular sieves, or the like.

The nitrogen membrane filter 118′ is connectable to a gas storage tank 119′, which is configured to receive and store the separated compressed nitrogen gas therein. However, it should be appreciated that gas storage tank is not essential, and instead the nitrogen gas may be supplied directly to the output 122′ (an example of a separated gas outlet, or gas outlet).

As illustrated in FIG. 12, the gas generation apparatus/gas processing apparatus B′ comprises a number of other components that are used to operate the system. These components are well understood in the operation of gas generation apparatuses/gas processing apparatuses and no further explanation of their operation will be provided here. The gas generation apparatus/gas processing apparatus B′ of FIG. 12 includes the following components:

11′. Compressor inlet filter
12′. Compressor
13′. Cooling coil
14′. Duplex filter
16′. Non-return valve
17′. Re-heating coil
110′. Dryer membrane
111′. Storage tank
112′. Safety relief valve
113′. Pressure gauge (tank)
114′. Pressure switch
115′. Mass Flow controller
116′. RAC Filter
117′. Pressure regulator
118′. Nitrogen membrane
119′. Storage tank
120′. Pressure gauge (Nitrogen)
121′. Pressure gauge (Air)
122′. Outlet port (Nitrogen)
123′. Outlet port (Air)
124′. Outlet port (Drain)

The operation of the gas generation apparatus/gas processing apparatus B′ and each fluid level control apparatus 30 is substantially identical to that of the gas generation apparatus/gas processing apparatus A′.

Again, draining the water from each fluid level control apparatus 30 in the manner described above does not significantly reduce the pressure in the gas generation apparatus/gas processing apparatus B′.

Providing a fluid level control apparatus 30 in accordance with the present invention ensures that the gas produced by the gas generation apparatus/gas processing apparatus C′, D′, A′, B′ is consistently of a high purity. This is because the fluid level control apparatus 30 allows the pressure in the apparatus C′, D′, A′, B′ to effectively be maintained during the draining of water from the filter units 2a′, 4b′, 14′ and 18, 19, 110. This ensures that there is no pressure drop in the compressed air, or a reduction in flow rate, as it passes through the nitrogen membrane 5a′, 7b′, 115, 118′.

Furthermore, the fluid level control apparatus 30 measures the water level in the body portion 32 and automatically drains the water therefrom. This is carried out by the control module 38 receiving fluid level signals from each of the first and second fluid sensor modules 34, 36 and operating the fluid outlet 40 in dependence on those signals. With some known gas generation apparatuses the drain valve is set to open and close at a predetermined period. This is not based on any knowledge of the water level in the filter unit. Frequent opening and closing the drain valve often reduces the operational life expectancy of the components, whilst infrequent opening and closing the drain valve may result in a build-up of water in the filter unit and water being transferred to the nitrogen membrane, or external equipment to which the gas is being supplied. This may cause malfunction of the gas generation apparatus and the external equipment connected thereto. Furthermore, opening the drain valve for too long a period may dramatically reduce the pressure in the apparatus, as large amounts of compressed air may escape.

Also, providing a fluid level control apparatus 30 as described above means that it is possible to reduce the number of components required in the gas generation apparatus. For example, as the fluid level control apparatus 30 is operable to control the fluid outlet valve 40, it is possible to remove the compressor offload valves 3 and silencer 4 from the gas generation apparatus A of FIG. 3, and the compressor offload valves 8 and silencer 9 from the gas generation apparatus B of FIG. 4. This is because the fluid level control apparatus 30 and fluid outlet valve 40 can perform the function of releasing the pressure in the apparatus before the compressors are powered on.

Furthermore, by using the fluid level control apparatus 30 to monitor the water level in the filters, failure detection may be possible. That is, if the control module 38 of each apparatus 30 receives an unexpected signal (or no signal), then an alarm may be triggered which indicates that there is a malfunction. Early detection of such malfunctions reduces the possibility of severe damage to the gas generation apparatus, or external equipment, as the gas generation apparatus can be switched off very quickly upon an alarm being triggered.

Also, the fluid level control apparatus 30 of the present invention intrinsically adapts its operation to the atmospheric moisture conditions of the environment in which it is operating. That is, the control and operation of the fluid outlet valves 40 are determined by the atmospheric moisture conditions in which the fluid level control apparatus 30 is operating. This is beneficial over systems which simply used timed operation of valve actuation control, as such systems are not suited to all environmental conditions. Timed release of moisture build up does not take into consideration the actual build up of moisture in the system, which can lead to problems highlighted above, such as the affect on purity of separated gas and moisture or water damage to filters and other attached equipment.

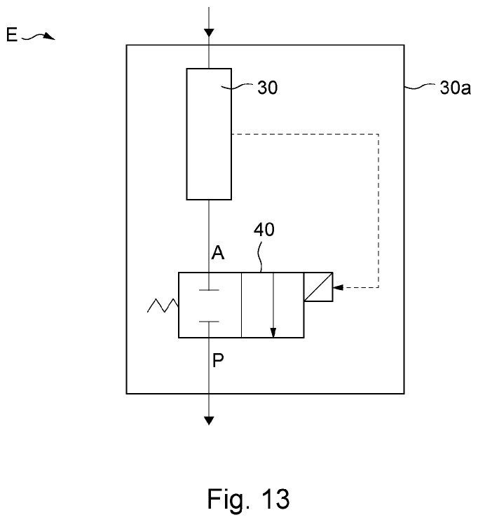

With reference to FIG. 13, a fluid level control system E is illustrated. The fluid level control system E of the present invention includes a fluid level control apparatus 30 according to the present invention and a housing 30a. As illustrated, the fluid level control apparatus 30 is housed in the housing 30a.

The fluid level control system E may also include a fluid outlet valve 40. The fluid outlet valve 40 may also be housed in the housing 30a.

The fluid level control system E may be used with gas generation apparatuses/gas processing apparatuses C′, D′, A′, B′. The fluid level control system E may be a separate component.

The operation of the fluid level control apparatus 30 and outlet valve 40 is the same as that described above with reference to FIGS. 5 to 12. That is, the control module 38 operates in dependence on signals received from the first and second sensor modules 34, 36 and controls the operation of the fluid outlet valve 40 to drain fluid from the body portion 32 of the fluid level control apparatus 30.

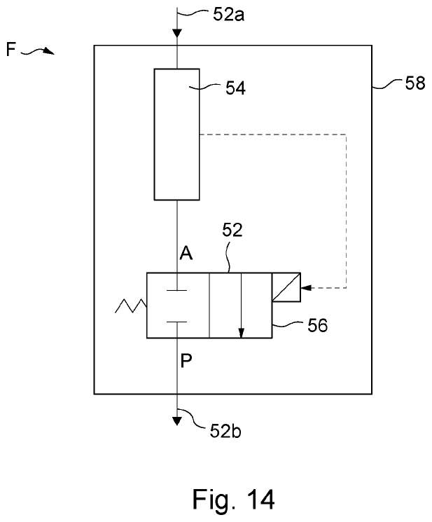

With reference to FIG. 14, a valve apparatus F is illustrated. The valve apparatus F includes a valve 52 and a control module 54. The control module 54 is configured to control the operation of the valve 52.

The valve apparatus F has a fluid inlet 52a and a fluid outlet 52b. The valve 52 controls the flow of fluid out of the fluid outlet 52b.

The valve apparatus F may be for a fluid level control apparatus of the present invention. The valve may be for a gas generation apparatus/gas processing apparatus of the present invention. The valve apparatus may be for a fluid drain system of a gas generation apparatus/gas processing apparatus. The valve apparatus may be for a fluid drain system of a compressor.

The valve apparatus F may be automatically operable. The control module may be configured to monitor one or more control signals and control the operation of the fluid outlet valve. The control module 54 may be configured to operate in dependence on one or more control signals.

The valve apparatus F may be operable to control the fluid level in a gas generation apparatus/gas processing apparatus. The valve apparatus F may be operable to control the fluid level in the fluid drainage system of a gas generation apparatus/gas processing apparatus. The valve apparatus F may be operable to control the fluid level in the fluid drainage system of a moisture removal system of a gas generation apparatus/gas processing apparatus. The valve apparatus F may be operable to control the fluid level in the fluid drainage system of a moisture removal system of a compressed air system.

The valve apparatus F may be operable to control the water level in a gas generation apparatus/gas processing apparatus. The valve apparatus F may be operable to control the water level in the fluid drainage system of a gas generation apparatus/gas processing apparatus. The valve apparatus F may be operable to control the water level in the fluid drainage system of a moisture removal system of a gas generation apparatus/gas processing apparatus. The valve apparatus F may be operable to control the water level in the fluid drainage system of a moisture removal system of a compressed air system.

As illustrated, the valve 52 includes a body portion 56. The control module 54 may be mounted on, or in, the body portion 56.

The valve apparatus F also includes a housing 58. The valve apparatus F is located in the housing 58.

The control module 54 may operate in an identical manner to the control module 38 described above.

The control module 54 is operable to send a valve control signal to the valve 52.

The control module 54 includes a micro controller (MC). The MC may include a power supply module, an input/output (I/O) module, a processor module, and a programming module. The control module 54 may include one or more programmable memory devices. The control module 54 may include one or more memory storage devices. The control module 54 may include one or more computing devices. The control module 54 may be operable to run one or more computer programs.

The control module 54 is operable from a 24v/0.1 A DC power source. However, it should be appreciated that other operational power settings may be used.

The control module 54 is configured to send the control signal to the valve 52. The control module 54 is therefore configured to control the opening and closing of the valve 52. The control module 54 may be configured to actuate the valve 52 and control the flow of fluid, flow rate of fluid, through the valve 52.

In the embodiment illustrated and describe here, the valve 52 is an electronically-controlled valve, such as a solenoid valve.

The control module 54 is operable to modulate the opening and closing of the valve 52. The control module 54 may be operable to open and close the valve utilising a variable pulse.

The control module 54 may be operable to pulse the opening and closing of the valve 52. The control module 54 may be operable to pulse the opening and closing of the valve 52 at one or more predetermined intervals. The control module 54 may be operable to pulse the opening and closing of the valve 52 at intervals dependent on one or more system conditions linked to the valve apparatus F. The control module 54 may be operable to pulse the opening and closing of the valve 52 at intervals dependent on one or more system conditions of a system to which the valve apparatus F is connected. The control module 54 may be operable to pulse the opening and closing of the valve 52 at intervals dependent on one or more system conditions of a gas generation apparatus, compressor, or the like.

The control module 54 is operable to vary the periods, or frequencies, at which the valve 52 opens and closes. The control module 54 may use pulse width modulation (PWM) to operate the opening and closing of the valve 52.

The valve 52 may be a drain, or drainage, valve.

The control module 54 may be configured to control the operation of the valve 52.

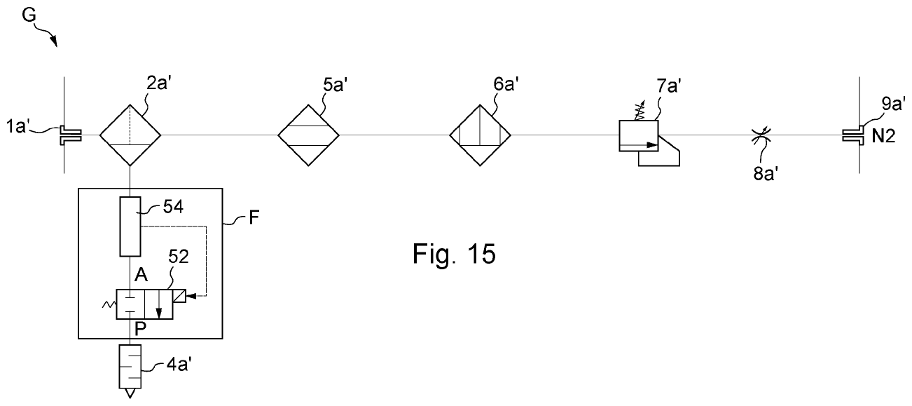

With reference to FIG. 15, a gas generation apparatus/gas processing apparatus G in accordance with the present invention is illustrated.

The gas generation apparatus/gas processing apparatus G is substantially identical to the gas generation apparatus/gas processing apparatus C′, the only difference being that the valve apparatus F has replaced the fluid level control system 30′. All other components, and the operation thereof, are identical to those described above. The same reference numbers between identical components have been used for consistency.

The operation of the gas generation apparatus/gas processing apparatus G is substantially identical to the gas generation apparatus/gas processing apparatus C′, the only difference being the draining of fluid from the filter 2a′ is performed by the valve apparatus F. The control module 54 operates the actuation of the valve 52, as described above, to allow fluid to drain from the filter 2a′.

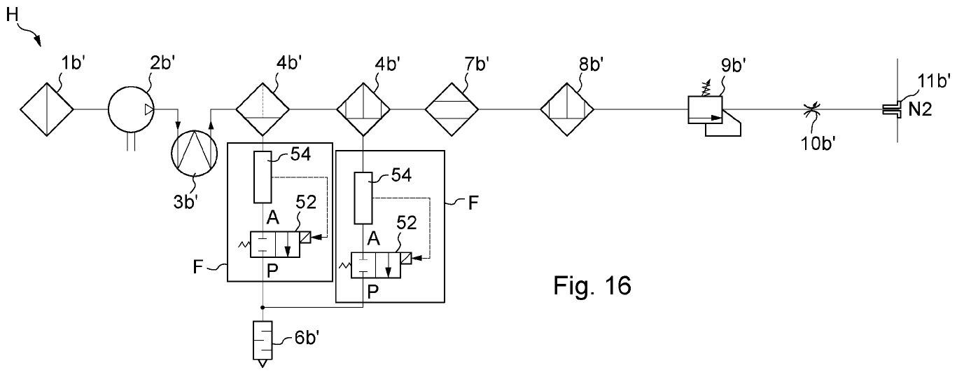

With reference to FIG. 16, a gas generation apparatus/gas processing apparatus H in accordance with the present invention is illustrated.

The gas generation apparatus/gas processing apparatus H is substantially identical to the gas generation apparatus/gas processing apparatus D′, the only difference being that the valve apparatus F has replaced the fluid level control system 30′. All other components, and the operation thereof, are identical to those described above. The same reference numbers between identical components have been used for consistency.

Again, the operation of the gas generation apparatus/gas processing apparatus H is substantially identical to the gas generation apparatus/gas processing apparatus D′, the only difference being the draining of fluid from the filters 4b′ is performed by the valve apparatus F. Again, the control module 54 operates the actuation of the valve 52, as described above, to allow fluid to drain from the filters 4b′.

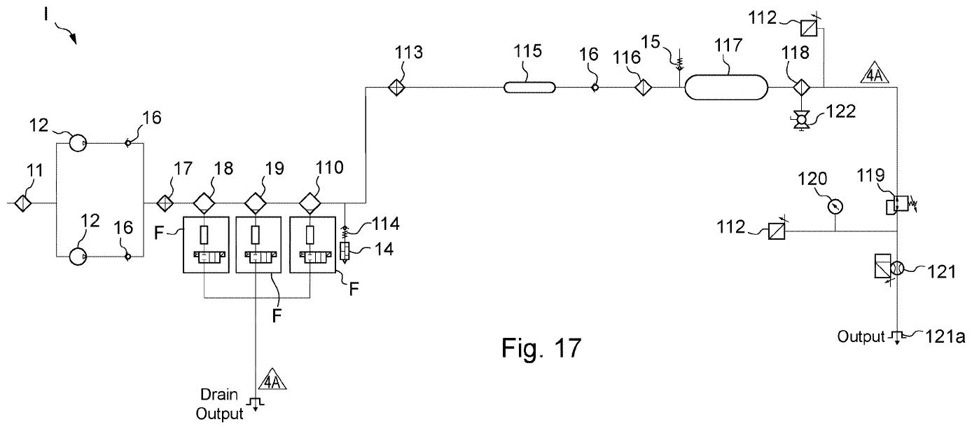

With reference to FIG. 17, a gas generation apparatus/gas processing apparatus I in accordance with the present invention is illustrated.

The gas generation apparatus/gas processing apparatus I is substantially identical to the gas generation apparatus/gas processing apparatus A′, the only difference being that the valve apparatus F has replaced the fluid level control system 30′. All other components, and the operation thereof, are identical to those described above. The same reference numbers between identical components have been used for consistency.

Again, the operation of the gas generation apparatus/gas processing apparatus I is substantially identical to the gas generation apparatus/gas processing apparatus A′, the only difference being the draining of fluid from the filters 18, 19, 110 is performed by the valve apparatus F. Again, the control module 54 operates the actuation of the valve 52, as described above, to allow fluid to drain from the filters 18, 19, 110.

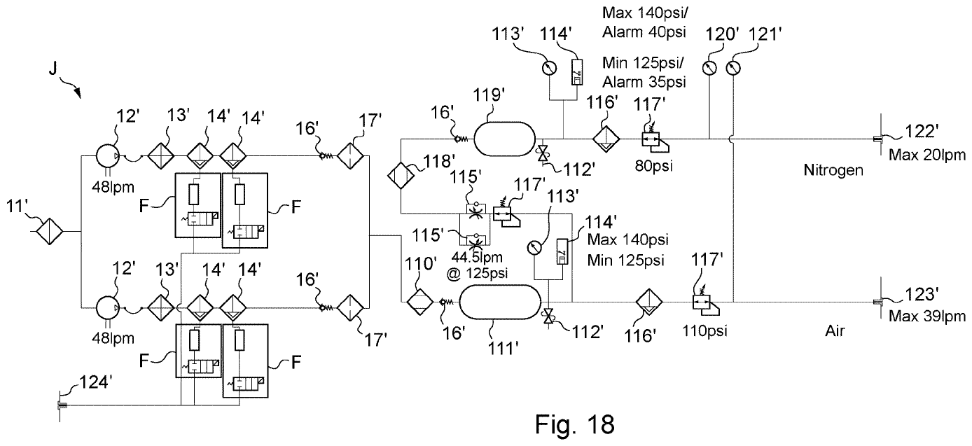

With reference to FIG. 18, a gas generation apparatus/gas processing apparatus J in accordance with the present invention is illustrated.

The gas generation apparatus/gas processing apparatus J is substantially identical to the gas generation apparatus/gas processing apparatus B′, the only difference being that the valve apparatus F has replaced the fluid level control system 30′. All other components, and the operation thereof, are identical to those described above. The same reference numbers between identical components have been used for consistency.

Again, the operation of the gas generation apparatus/gas processing apparatus J is substantially identical to the gas generation apparatus/gas processing apparatus/gas processing apparatus B′, the only difference being the draining of fluid from the filters 14′ is performed by the valve apparatus F. Again, the control module 54 operates the actuation of the valve 52, as described above, to allow fluid to drain from the filters 14′.

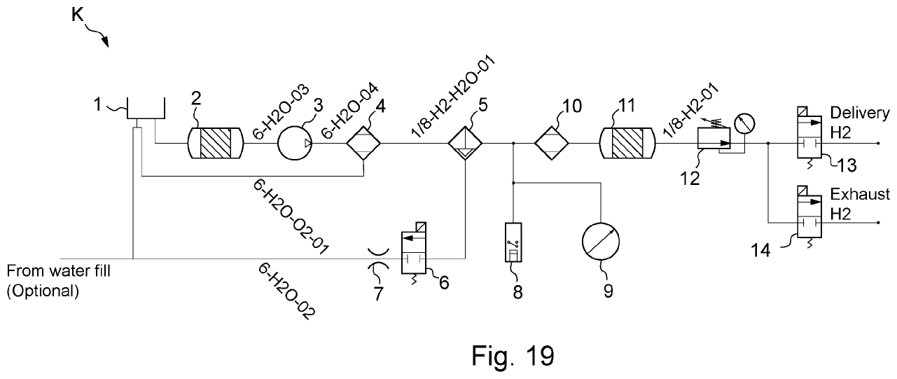

FIG. 19 is a schematic example of a known gas generation apparatus. In the example illustrated here, the apparatus generates hydrogen gas from water.

The operation of such gas generation apparatuses is well understood and no detailed explanation of the operation of the apparatuses will be provided here.

The gas generation apparatus K of FIG. 19 includes the following components:

1 Water tank
2 Deioniser Column
3 Water Pump
4 Electrolysis Cell
5 Water Separation Tank
6 Separation Valve
7 Fixed Orifice (0.5 mm)
8 Over Pressure Switch
9 Pressure Transducer
10 Dryer Membrane
11 Column Dryer/Molecular Sieve
12 Pressure Regulator
13 Delivery Valve
14 Exhaust Valve

As is known with such gas generation apparatuses, the separation valve 6 is used to drain accumulate water that is removed from the hydrogen by the water separation tank 5. The separation valve 6 often operates with a single fluid level sensor which, when triggered by the presence of water, opens to drain the accumulated water. The valve is opened for a fixed period of time, which is assumed to be long enough to allow the water to be drained.

However, with such known systems, it is difficult to be certain that the separation valve 6 is working properly, and that the accumulated water is being drained. If the water is not drained by the separation valve 6, then the hydrogen that passes from the water separation tank will include a high level of water vapour, water moisture etc., then severe damage may occur to components of the apparatus, notably the dryer membrane 10 and the column dryer/molecular sieve 11. It is also possible that the gas generated by the apparatus could contain an unacceptable level of water, or water vapour, which could damage further apparatuses to which the gas is supplied.

With known systems, the separation valve 6 drains the accumulated water by opening and closing for a set period of time. This period of time is determined by calculating the length of time that the valve needs to be open in order to drain an expected volume of accumulated water therefrom. The expected volume of water is the volume of water that is expected to have been accumulated by the water separation tank 5 over a certain period of operating time of the generator. The period of time for opening and closing the valve is often a factory pre-set, based on expected operating conditions of the gas generator. However, operating field conditions of the gas generator means that it is often difficult to understand if the separation valve 6 is working properly, which is inconvenient and may lead to one or more of the problems described above.

As stated above, the inventors have appreciated the shortcomings with such known gas generation apparatuses K.

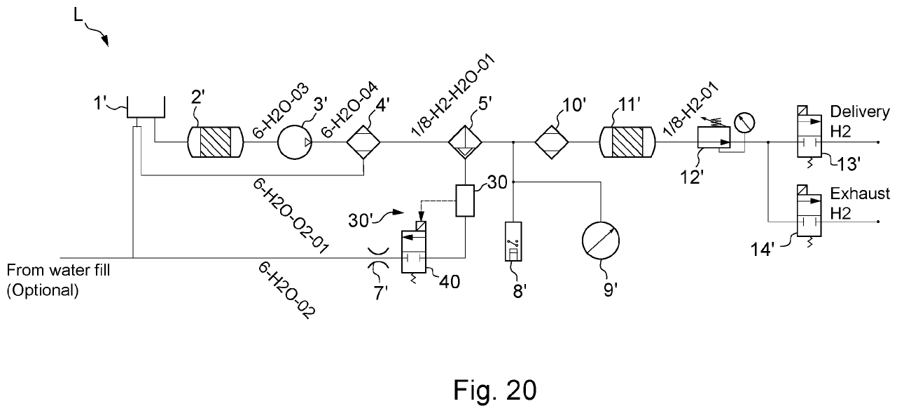

With reference to FIG. 20, a gas generation apparatus L is illustrated. As described further below, a fluid level control apparatus 30 may be used in the gas generation apparatus L.

The operation of the gas generation apparatus L and the fluid level control apparatus 30 will now be described.

As illustrated in FIG. 20, water is fed from the water tank 1′ (an example of a fluid inlet) into the deioniser column 2′ before being pumped by the water pump 3′ (an example of a fluid pump) to the electrolysis cell 4′ (an example of a first fluid separator). In the embodiment illustrated and described here the electrolysis cell 4′ is a proton-exchange membrane cell. However, it should be appreciated that any other apparatus suitable for separating hydrogen from water may be used.

The output from the electrolysis cell 4′ is hydrogen gas, water and oxygen. The hydrogen gas may include water vapour, water moisture, or water particles, and may be referred to as wet hydrogen. This hydrogen then enters the water separation tank 5′ (an example of a second fluid separator), where the water (an example of a fluid) is separated therefrom. In the embodiment illustrated and described here, the water separation tank 5′ provides a cavity, or void, which allows the water to accumulate inside the tank. This accumulated water then enters the fluid inlet 32a of the fluid level control apparatus 30. The water from the electrolysis cell 4′ may be returned to the water tank 1′, and the oxygen from the electrolysis cell 4′ may be vented to atmosphere.

Hydrogen gas from the water separation tank 5′ then proceeds through a dryer membrane 10′ and a column dryer/molecular sieve 11′, before being passed to the delivery valve 13′ (an example of a gas outlet). The other components of the gas generation apparatus L are well understood and will not be described further here.

The gas generation apparatus L of FIG. 20 includes the following components:

| | |
|---|---|
| 1′ Water tank/fluid inlet | 8′ Over Pressure Switch |
| 2′ Deioniser Column/Deioniser apparatus | 9′ Pressure Transducer |
| 3′ Water Pump/Fluid Pump | 10′ Dryer Membrane |
| 4′ Electrolysis Cell/First Fluid | 11′ Column Dryer/Molecular |
| Separator | Sieve |
| 5′ Water Separation Tank/Second Fluid | 12′ Pressure Regulator |
| Separator | |
| 30 Fluid Level Control Apparatus | 13′ Delivery Valve/Gas Outlet |
| 7′ Fixed Orifice (0.5 mm) | 14′ Exhaust Valve |
| 40 Outlet Valve | |

Continued operation of the gas generation apparatus L results in a build-up of water in the fluid level control apparatus 30.

The operation of the fluid level control apparatus 30 is identical to the manner described above in other gas generation apparatuses/gas processing apparatuses of the present invention.

Providing a fluid level control apparatus 30 in accordance with the present invention ensures that it is easy to identify that the water is being drained from the apparatus, as the control module 38 is operable to expect to receive signals from the first and second sensor modules 34, 36. The absence of an expected signal from the sensor modules 34, 36 (or receipt of a signal at an unexpected time from the sensor modules 34, 36) triggers an alarm situation, which indicates that there may be a fault with the apparatus, and the appropriate action may be taken. This removes the need to rely on predetermined opening and closing periods of the valve based on expected operating conditions of the generator. Early detection of such malfunctions reduces the possibility of severe damage to the gas generation apparatus, or external equipment, as the gas generation apparatus can be switched off very quickly upon an alarm being triggered.

Furthermore, as the fluid level control apparatus 30 in accordance with the present invention functions as a stand-alone component, the need to include specific code for the control of the valve in the control software for the gas generation apparatus is removed, which reduces the complexity of the software. The need to include components for the control of the valve on control PCBs of the gas generation apparatus is also removed, which reduces the complexity of the same.

Modifications and improvements may be made to the above without departing from the scope of the present invention. For example, although the sensor modules 34 and 36 of the fluid level control apparatus 30 have been illustrated and described above as optical sensors, with light emitters 34a, 36a and light detectors 34b, 36b, it should be appreciated that other suitable sensor modules may be used.

Furthermore, it should also be appreciated that the fluid level control apparatus, or apparatuses, 30 and fluid outlet valve, or valves, 40 may be provided in a housing 30a, 58, such that the fluid level control system 30′ may be provided as a discrete, or stand alone, component.

Also, it should be appreciated that the gas separator may be considered as a filter, or a filter unit. The purpose of which is to separate, or filter, constituent components of atmospheric air. That is, the gas separator may allow only one separated constituent component of atmospheric air to be produced, or output, therefrom.

Furthermore, it should be appreciated that, although the fluid level control apparatus of the present invention has been illustrated and described here in use with a gas generation apparatus/gas processing apparatus, the fluid level control apparatus may be used in other systems, or arrangements.

In other systems, or arrangements, it will be appreciated that the fluid level control apparatus may operate to control the fluid level in at least a portion of the system, or arrangement, by allowing the body portion to be fluidly connected with the fluid in the system, such that the sensor modules may sense the fluid level and the control module may control the operation of a valve. The fluid level control apparatus of the present invention may therefore may function as a stand alone component that may be fitted, or retrofitted, to an existing system, or arrangement, where it is necessary to remove fluid, whilst reducing pressure drop therein.

Also, it should be appreciated that, although the valve apparatus of the present invention has been illustrated and described here in use with a gas generation apparatus/gas processing apparatus, the valve apparatus may be used in other systems, or arrangements. In other systems, or arrangements, it will be appreciated that the valve apparatus may operate to vent, or discharge, fluid from the system, or arrangement, by allowing the valve to be fluidly connected with fluid in the system, and the control module may control the operation of the valve. The valve apparatus of the present invention may therefore may function as a stand alone component that may be fitted, or retrofitted, to an existing system, or arrangement, where it is necessary to remove fluid, whilst reducing pressure drop therein.

Furthermore, although the fluid level control apparatus 30 has been illustrated and described here with reference to a gas generation apparatus that includes a gas separator (nitrogen membrane), it should be appreciated that the gas separator is not essential and the fluid level control apparatus may be used in a system without a gas separator. A gas generation apparatus in this arrangement without a gas separator is an example of a gas processing apparatus, where atmospheric air may be processed by a compressor unit, a filter unit and the fluid level control apparatus. The gas processing apparatus produces atmospheric air which as a reduced water/vapour content.

Also, although the fluid level control apparatus 30 has been illustrated and described here with reference to a gas generation apparatus that includes a compressor unit, it should be appreciated that the compressor unit is not essential, and the fluid level control apparatus may be used in a system without a compressor unit. A gas generation apparatus in this arrangement without a compressor unit is an example of a gas processing apparatus, where atmospheric air may be processed by a filter unit and the fluid level control apparatus. The gas processing apparatus produces atmospheric air which as a reduced water/vapour content.

Furthermore, although each sensor module 34, 36 has been described above as being an optical sensor, it should be appreciated that each sensor module 34, 36 may be considered as an electromagnetic radiation sensor, such that they may be able to transmit and/or detect electromagnetic radiation. Each sensor module 34, 36 may be operable to operate in the visible and non-visible portion or the electromagnetic spectrum. In this arrangement the sensor modules 34, 36 may be electromagnetic radiation sensors, with an electromagnetic radiation emitter and an electromagnetic radiation detector.

1. A gas generation apparatus comprising:
a gas inlet, the gas inlet being configured to allow gas to enter the apparatus;
a filter unit, the filter unit being configured to filter the gas from the gas inlet;
a fluid level control system, the fluid level control system being operable to control the level of fluid removed from the gas by the filter unit, the fluid level control system comprising:
a fluid level control apparatus comprising:
a body portion having a fluid inlet and a fluid outlet;
a first sensor module, the first sensor module being configured to sense fluid at a first position within the body portion;
a second sensor module, the second sensor module being configured to sense fluid at a second position within the body portion; and
a control module, the control module being configured to receive output signals from the first and second sensor modules, and send a fluid outlet valve control signal; and
a fluid outlet valve;
a gas separator, the gas separator being configured to separate the gas from the filter unit; and
a separated gas outlet, the separated gas outlet being configured to receive the separated compressed gas from the gas separator.

2. The gas generation apparatus of claim 1, wherein the fluid level control apparatus is automatically operable, the control module being programmed to monitor the operation of the first and second sensor modules and control the operation of the fluid outlet valve.

3. The gas generation apparatus of claim 1, wherein each sensor module is configured to output at least one signal that is indicative of detected fluid at the position of the sensor, and at least one signal that is indicative of no detected fluid at the position of the sensor.

4. The gas generation apparatus of claim 1, wherein the first sensor module is located towards a lower portion of the body portion, and the second sensor module is located towards an upper portion of the body portion.

5. The gas generation apparatus of claim 1, wherein the first and second sensor modules are optical sensors, each sensor module including a light emitter and a light detector.

6. The gas generation apparatus of claim 1, wherein the first and second sensor modules protrude into the body portion, such that they may come into contact with fluid in the body portion during use.

7. (canceled)

8. The gas generation apparatus of claim 1, wherein the control module is configured to control the opening and closing of the fluid outlet valve of the fluid level control apparatus when a signal is received from the second sensor module indicating that fluid is sensed at the second position, and close the fluid outlet valve when a signal is received from the first sensor module indicating that fluid is sensed at the first position.

9. The gas generation apparatus of claim 1, wherein the control module is configured to control the fluid level in the body portion of the fluid level control apparatus through monitoring the operation of the first and second sensor modules and controlling the operation of the fluid outlet valve.

10. The gas generation apparatus of claim 1, wherein the fluid outlet valve is an electronically-controlled valve and the control module is configured to control the actuation of the fluid outlet valve.

11. The gas generation apparatus of claim 10, wherein the control module controls the actuation of the fluid outlet valve with a variable pulse, or with pulse width modulation (PWM).

12. The gas generation apparatus of claim 10, wherein the control module is configured to pulse the opening and closing of the fluid outlet valve at intervals dependent on one or more external system conditions linked to the fluid outlet valve.

13. The gas generation apparatus of claim 10, wherein the control module is operable to vary the periods, or frequencies, at which the fluid outlet valve opens and closes.

14. The gas generation apparatus of claim 1, wherein the filter unit of the gas generation apparatus is a fluid filter unit and the gas separator of the gas generation apparatus is a gas separator unit, the gas separator being operable to separate the compressed gas from the filter unit into at least one of its constituent gas components.

15.-17. (canceled)

18. A fluid level control apparatus comprising:
a body portion having a fluid inlet and a fluid outlet;
a first sensor module, the first sensor module being configured to sense fluid at a first position within the body portion;
a second sensor module, the second sensor module being configured to sense fluid at a second position within the body portion; and
a control module, the control module being configured to receive output signals from the first and second sensor modules, and send a fluid outlet valve control signal.

19. The fluid level control apparatus of claim 18, wherein the fluid level control apparatus is automatically operable, the control module being programmed to monitor the operation of the first and second sensor modules and control the operation of a fluid outlet valve.

20.-26. (canceled)

27. The fluid level control apparatus of claim 19, wherein the fluid outlet valve is an electronically-controlled valve and the control module is configured to control the actuation of the fluid outlet valve.

28. The fluid level control apparatus of claim 27, wherein the control module controls the actuation of the fluid outlet valve with a variable pulse, or with pulse width modulation (PWM).

29. (canceled)

30. (canceled)

31. The fluid level control apparatus of any of claim 18, wherein the fluid level control apparatus further comprises a fluid outlet valve.

32.-47. (canceled)

48. A gas processing apparatus comprising:
a gas inlet, the gas inlet being configured to allow gas to enter the apparatus;
a filter unit, the filter unit being configured to filter the gas from the gas inlet;
a fluid level control system, the fluid level control system being operable to control the level of fluid removed from the gas by the filter unit, the fluid level control system comprising:
a fluid level control apparatus comprising:
a body portion having a fluid inlet and a fluid outlet;
a first sensor module, the first sensor module being configured to sense fluid at a first position within the body portion;
a second sensor module, the second sensor module being configured to sense fluid at a second position within the body portion; and
a control module, the control module being configured to receive output signals from the first and second sensor modules, and send a fluid outlet valve control signal; and
a fluid outlet valve;
a gas outlet, the gas outlet being configured to receive the gas from the filter unit.

49.-51. (canceled)

52. A gas generation apparatus comprising:
a fluid inlet, the fluid inlet being configured to allow fluid to enter the apparatus;
a first fluid separator, the first fluid separator being configured to separate a gas from the fluid from the fluid inlet;
a second fluid separator, the second fluid separator being configured to separate a fluid from the gas from the first fluid separator;
a fluid level control system, the fluid level control system being operable to control the level of fluid removed from the gas by the second fluid separator, the fluid level control system comprising:
a fluid level control apparatus comprising:
a body portion having a fluid inlet and a fluid outlet;
a first sensor module, the first sensor module being configured to sense fluid at a first position within the body portion;
a second sensor module, the second sensor module being configured to sense fluid at a second position within the body portion; and
a control module, the control module being configured to receive output signals from the first and second sensor modules, and send a fluid outlet valve control signal; and
a fluid outlet valve; and
a gas outlet, the gas outlet being configured to receive gas from the second fluid separator.

53. (canceled)
